(19) United States
(12) Patent Application Publication
(10) Pub. No.: US 2026/0370067 A1
(43) Pub. Date: Nov. 19, 2026

(54) STATOR, MOTOR, AND METHOD FOR MANUFACTURING STATOR

(71) Applicant: NIDEC CORPORATION, Kyoto (JP)

(72) Inventors: Yabo HU, Kyoto (JP); Toru CHIKIRA, Kyoto (JP); Takeshi HONDA, Kyoto (JP); Hitoshi TAKEUCHI, Kyoto (JP); Sou BOKU, Kyoto (JP)

(21) Appl. No.: 19/735,493

(22) Filed: Jul. 9, 2026

Related U.S. Application Data
(63) Continuation of application No. PCT/JP2025/000029, filed on Jan. 6, 2025.

(30) Foreign Application Priority Data
Jan. 10, 2024 (JP) 2024-001884

(51) Int. Cl. H02K 1/16; H02K 1/04; H02K 1/2793; H02K 3/48; H02K 7/00; H02K 15/02; H02K 15/065; H02K 15/122; H02K 16/02

(52) U.S. Cl. CPC H02K 1/16; H02K 1/04; H02K 1/2793; H02K 3/48; H02K 7/003; H02K 15/02; H02K 15/065; H02K 15/122; H02K 16/02

(57) ABSTRACT

One aspect of a stator of the present disclosure is a stator opposing, in an axial direction, a rotor rotatable around a center axis, the stator including a plurality of teeth arranged in a circumferential direction, coils respectively mounted on the plurality of teeth, and a first resin portion holding the plurality of teeth. The first resin portion includes insulator portions located between the teeth and the coils.

### CROSS-REFERENCE TO RELATED APPLICATIONS

This application is a continuation of International Application No. PCT/JP2025/000029, filed on Jan. 6, 2025, which claims priority to Japanese Patent Application No. 2024-001884, filed on Jan. 10, 2024, the entire contents of which are incorporated herein by reference.

### TECHNICAL FIELD

The present disclosure relates to a stator, a motor, and a method for manufacturing the stator.

### BACKGROUND

An axial gap motor in which a rotor and a stator oppose each other in an axial direction has advantages such as light weight and high torque density. As a known example, an axial gap motor including a plurality of stator cores molded by insert-molding a core body made of a plurality of steel sheets inside a bobbin is disclosed.

The known axial gap motor requires the plurality of stator cores to be separately coupled to each other and arranged in an annular shape, which complicates a manufacturing process.

### SUMMARY

One aspect of a stator of the present disclosure is a stator opposing, in an axial direction, a rotor rotatable around a center axis, the stator including: a plurality of teeth arranged in a circumferential direction; coils respectively mounted on the plurality of teeth; and a first resin portion holding the plurality of teeth. The first resin portion includes insulator portions located between the teeth and the coils.

One aspect of a motor of the present disclosure includes the stator and the rotor.

One aspect of a method for manufacturing a stator of the present disclosure is a method for manufacturing a stator opposing, in an axial direction, a rotor rotatable around a center axis, the method including: an arranging step of arranging a plurality of teeth in a cavity of a mold; a molding step of filling the cavity with resin, molding a first resin portion, forming an insulator portion on a surface of each of the teeth, and holding the plurality of teeth with the first resin portion; and a mounting step of mounting a coil on the teeth via the insulator portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is an exploded perspective view of a motor of a first embodiment;

FIG. 2 is a sectional view of the motor of the first embodiment;

FIG. 3 is a perspective view showing a plurality of teeth of the first embodiment;

FIG. 4 is a perspective view of the plurality of teeth and a first resin portion of the first embodiment;

FIG. 5 is a partially enlarged view of FIG. 4;

FIG. 6 is a schematic sectional view of a mold for molding the first resin portion of the first embodiment;

FIG. 7 is a sectional view of the mold along a radial direction taken along line VII-VII of FIG. 6;

FIG. 8 is a perspective view in which coils and busbars are assembled to a molded component of the first embodiment;

FIG. 9 is a perspective view in which coils, busbars, and a shaft are assembled to the molded component of the first embodiment;

FIG. 10 is a perspective view in which each component is assembled to, and a second resin portion is filled in, the molded component of the first embodiment;

FIG. 11 is a perspective view showing a plurality of U-phase coils of the first embodiment;

FIG. 12 is a perspective view showing a plurality of V-phase coils of the first embodiment;

FIG. 13 is a perspective view showing a plurality of W-phase coils of the first embodiment;

FIG. 14 is a schematic view showing a steel sheet cutting step of a modification of the first embodiment;

FIG. 15 is a perspective view of a tooth of the modification of the first embodiment;

FIG. 16 is a perspective view of a stator of a second embodiment;

FIG. 17 is a perspective view of the stator of the second embodiment in which a second resin portion is omitted;

FIG. 18 is a perspective view of a motor of a third embodiment;

FIG. 19 is a perspective view of a molded component of the third embodiment;

FIG. 20 is an exploded perspective view of a plurality of teeth and a back yoke of the third embodiment;

FIG. 21 is a schematic sectional view of a mold for molding a first resin portion of the third embodiment;

FIG. 22 is a side view of an electric two-wheeled vehicle including the motor of any of the embodiments;

FIG. 23 is a perspective view of an unmanned aerial vehicle including the motor of any of the embodiments; and

FIG. 24 is a schematic view of an electric power steering device including the motor of any of the embodiments.

### DETAILED DESCRIPTION

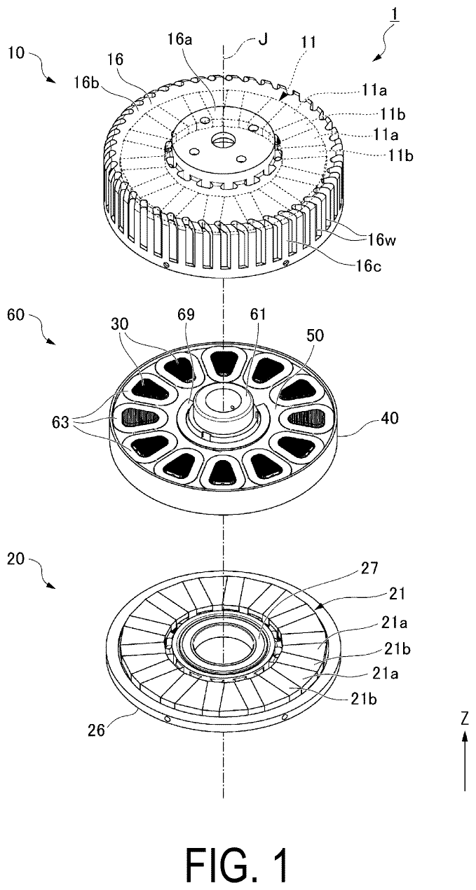

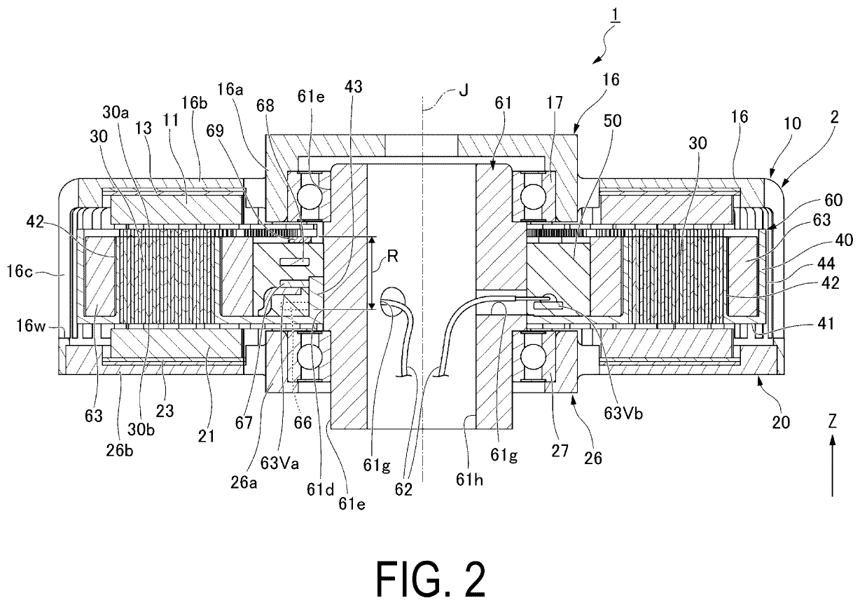

Hereinafter, a motor according to an embodiment of the present disclosure will be described with reference to the drawings. The scope of the present disclosure is not limited to the following embodiments, and can be optionally changed within the scope of the technical idea of the present disclosure. In each drawing, a Z-axis is illustrated as appropriate. The Z-axis is a virtual axis parallel to a center axis J described later. Further, the Z-axis is the vertical direction in which the positive side is “upper side” and the negative side is “lower side”. However, a posture of the motor with respect to the vertical direction in the present specification is an example for description, and does not limit the posture of the motor during use.

[First Embodiment] FIG. 1 is an exploded perspective view of a motor 1 of the first embodiment. FIG. 2 is a sectional view of the motor 1 of the first embodiment.

As shown in FIG. 1, the motor 1 of the present embodiment includes a pair of rotors 10 and 20 and a stator 60 arranged between the pair of rotors 10 and 20.

The stator 60 of the present embodiment opposes the rotors 10 and 20 in the axial direction with a gap therebetween. The motor 1 of the present embodiment is a single-stator double-rotor type axial gap motor. Further, the motor 1 of the present embodiment is a three-phase alternating-current motor.

<Rotor> The pair of rotors 10 and 20 is rotatable around a center axis J. In the present specification, the center axis J is a virtual line and extends in the vertical direction. In the following description, the axial direction of the center axis J may be simply referred to as “axial direction”, a direction corresponding to the lower side in the axial direction may be referred to as “one side in the axial direction”, and a direction corresponding to the upper side may be referred to as “the other side in the axial direction”. In the following description, a radial direction around the center axis J may be simply referred to as “radial direction” and a circumferential direction around the center axis J may be simply referred to as “circumferential direction”.

As shown in FIG. 2, one of the pair of rotors 10 and 20 is located above the stator 60, and the other is located below the stator 60. The pair of rotors 10 and 20 synchronously rotates about the center axis J. According to the present embodiment, by sandwiching the stator 60 from both sides in the axial direction by the pair of rotors 10 and 20, it is possible to provide the motor 1 with high torque and high efficiency by effectively using upper and lower magnetic fluxes of the stator 60.

In the following description, when the pair of rotors 10 and 20 are distinguished from each other, one of them located above is referred to as a first rotor 10, and the other located below is referred to as a second rotor 20. The first rotor 10 and the second rotor 20 are coupled to each other to constitute a rotor coupling body 2.

As shown in FIG. 1, the first rotor 10 includes a first frame 16, a first yoke portion 13, a first magnet group 11, and a first bearing 17.

The first frame 16 includes a bearing holder 16a, a disc portion 16b, and a cylindrical portion 16c. The bearing holder 16a holds an outer ring of the first bearing 17 from radially outside. Further, an inner ring of the first bearing 17 holds an outer circumferential surface of a shaft 61 of the stator 60 described later. By this, the first rotor 10 is rotatably supported with respect to the stator 60. The disc portion 16b extends radially outward from the bearing holder 16a. The cylindrical portion 16c has a cylindrical shape around the center axis J. The cylindrical portion 16c extends downward from an outer edge of the disc portion 16b. The cylindrical portion 16c surrounds the stator 60 from a radially outer side. The cylindrical portion 16c is provided with a plurality of ventilation holes 16w arranged along the circumferential direction.

The first yoke portion 13 has a plate shape extending along a plane orthogonal to the center axis J. The first yoke portion 13 is fixed to a lower surface of the disc portion 16b of the first frame 16. The first yoke portion 13 is in contact with an upper surface of the first magnet group 11.

As shown in FIG. 2, the first magnet group 11 has an annular shape around the center axis J. The first magnet group 11 includes a plurality of main magnets 11a and a plurality of sub-magnets 11b. The main magnets 11a and the sub-magnets 11b are provided in the first magnet group 11 in the same number. The main magnets 11a and the sub-magnets 11b are permanent magnets. The main magnets 11a and the sub-magnets 11b are alternately arranged along the circumferential direction. The main magnets 11a are magnetized in an axial direction Z. On the other hand, the sub-magnets 11b are magnetized in the circumferential direction. By this, the first magnet group 11 constitutes a Halbach array.

As shown in FIG. 1, the second rotor 20 includes a second frame 26, a second yoke portion 23, a second magnet group 21, and a second bearing 27.

The second frame 26 includes a bearing holder 26a and a disc portion 26b. The bearing holder 26a holds an outer ring of the second bearing 27 from radially outside. Further, an inner ring of the second bearing 27 holds the outer circumferential surface of the shaft 61 of the stator 60 described later. By this, the second rotor 20 is rotatably supported with respect to the stator 60. The disc portion 26b extends radially outward from the bearing holder 26a. A lower end portion of the cylindrical portion 16c of the first rotor 10 is coupled to an outer edge of the disc portion 26b. By this, the first rotor 10 and the second rotor 20 are fixed to each other.

The second yoke portion 23 has a plate shape extending along a plane orthogonal to the center axis J. The second yoke portion 23 is fixed to an upper surface of the disc portion 26b of the second frame 26. The second yoke portion 23 is in contact with a lower surface of the second magnet group 21.

As shown in FIG. 2, the second magnet group 21 has an annular shape around the center axis J. The second magnet group 21 has substantially the same configuration as the first magnet group 11. That is, the second magnet group 21 includes a plurality of main magnets 21a and a plurality of sub-magnets 21b alternately arranged in the circumferential direction. The second magnet group 21 constitutes a Halbach array.

The first magnet group 11 and the second magnet group 21 have opposite magnetic poles facing the stator 60 side. That is, the magnetic pole of the second rotor 20 arranged at a position overlapping an N pole of the first rotor 10 in the axial direction Z is an S pole. Similarly, the magnetic pole of the second rotor 20 arranged at a position overlapping an S pole of the first rotor 10 in the axial direction Z is an N pole.

<Stator> The stator 60 is located below the first rotor 10 and above the second rotor 20. The stator 60 has an annular shape surrounding the center axis J as viewed from the axial direction Z.

As shown in FIG. 1, the stator 60 includes a plurality of teeth 30, a plurality of coils 63, a first resin portion 40, a second resin portion 50, a plurality of busbars 66, 67, 68, and 69, and the shaft 61.

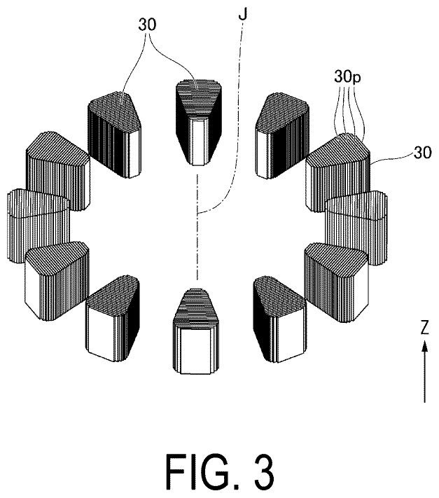

FIG. 3 is a perspective view showing the plurality of teeth 30 of the present embodiment.

The stator 60 of the present embodiment is provided with twelve teeth 30. The teeth 30 of the present embodiment are arranged at equal intervals along the circumferential direction.

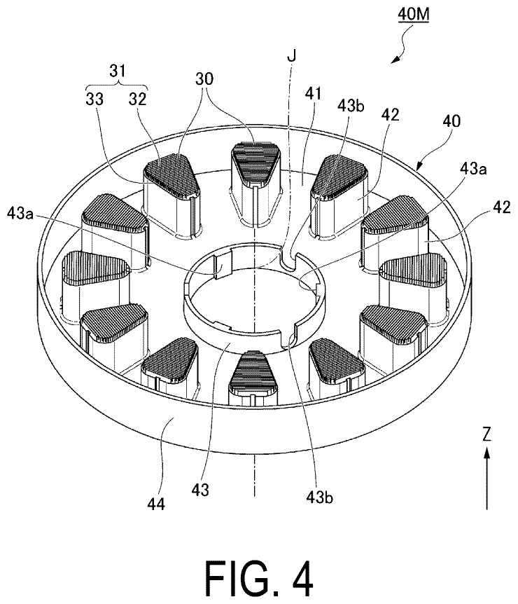

FIG. 4 is a perspective view of the plurality of teeth 30 of the present embodiment and the first resin portion 40 holding the plurality of teeth 30. The first resin portion 40 is molded by insert-molding for embedding and holding the plurality of teeth 30. The plurality of teeth 30 are held by the first resin portion 40, thereby maintaining a relative positional relationship. The first resin portion 40 is made of an insulating resin material. In the following description, the plurality of teeth 30 and the first resin portion 40 in a state in which the plurality of teeth 30 are insert-molded are referred to as a molded component 40M.

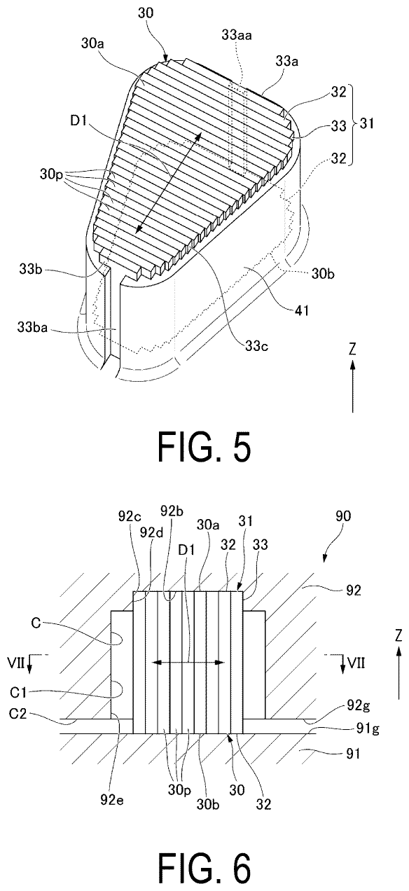

FIG. 5 is a partially enlarged view of FIG. 4. Each of the teeth 30 include a plurality of steel sheet pieces 30p stacked along a stacking direction D1. The steel sheet pieces 30p are made of what is called an electromagnetic steel sheet. In the present embodiment, the stacking direction D1 is a radial direction. Each of the steel sheet pieces 30p has a rectangular shape. Axial dimensions of each of the steel sheet pieces 30p are equal to each other. Further, width dimensions of the steel sheet pieces 30p along the circumferential direction are different from each other. In each of the teeth 30, central positions of the width dimensions of the plurality of steel sheet pieces 30p are aligned with each other. Further, in each of the teeth 30, the width dimensions of the plurality of steel sheet pieces 30p gradually increase toward radially outside, which is one side in the stacking direction D1, and decrease toward radially outside only in the vicinity of a radially outer end portion. Therefore, each of the teeth 30 has a substantially triangular shape whose dimension along the circumferential direction increases toward radially outside.

As shown in FIG. 4, the first resin portion 40 includes a plurality of insulator portions 42, a bottom wall portion 41, an outer wall portion 44, and an inner wall portion 43.

The insulator portions 42 and the teeth 30 are provided in the same number. The insulator portions 42 cover at least a part of outer side surfaces of the teeth 30. As shown in FIG. 2, the insulator portions 42 are positioned between the teeth 30 and the coils 63 and ensure insulation between the teeth 30 and the coils 63. The bottom wall portion 41 covers the plurality of coils 63 from the lower side (one side in the axial direction Z).

As shown in FIG. 4, the bottom wall portion 41 has a plate shape extending along a plane orthogonal to the center axis J. Further, the bottom wall portion 41 has an annular shape around the center axis J. The bottom wall portion 41 is connected to lower end portions of the insulator portions 42. By this, the bottom wall portion 41 connects the plurality of insulator portions 42 to each other. Further, the bottom wall portion 41 connects the outer wall portion 44 and the inner wall portion 43.

The outer wall portion 44 has a cylindrical shape around the center axis J. The outer wall portion 44 extends upward from an outer edge of the bottom wall portion 41. The outer wall portion 44 surrounds the plurality of teeth 30 from a radially outer side.

The inner wall portion 43 has a cylindrical shape around the center axis J. The inner wall portion 43 extends upward from an inner edge of the bottom wall portion 41. The inner wall portion 43 is located radially inward of the plurality of teeth 30. The inner wall portion 43 includes three anti-rotation portions 43a and three notch portions 43b. The anti-rotation portion 43a projects radially inward from an inner circumferential surface of the inner wall portion 43. The anti-rotation portion 43a extends in a rib shape along the axial direction Z. The three anti-rotation portions 43a are arranged at equal intervals along the circumferential direction. The notch portion 43b extends downward from an upper end of the inner wall portion 43. The notch portion 43b penetrates the inner wall portion 43 in the radial direction. The three notch portions 43b are arranged at equal intervals along the circumferential direction. The notch portion 43b is located between two anti-rotation portions 43a adjacent to each other in the circumferential direction.

According to the present embodiment, the first resin portion 40 includes the plurality of insulator portions 42 and the inner wall portion 43 connecting the plurality of insulator portions 42 to each other. Therefore, the first resin portion 40 of the present embodiment can hold the plurality of teeth 30 and relatively fix the plurality of teeth 30 to each other. According to the present embodiment, the first resin portion 40 having a function as an insulator further has a function of fixing the plurality of teeth 30 to each other. Therefore, the number of components of the stator 60 can be suppressed and the structure of the stator 60 can be simplified as compared with a case in which separate members having these functions are prepared. The manufacturing process can be simplified and the stator 60 can be manufactured at low cost as compared with a case in which the teeth provided with the insulators are separately coupled.

As shown in FIG. 5, a surface of each of the teeth 30 is provided with an exposed portion 31 exposed from the corresponding insulator portion 42. That is, the insulator portions 42 do not cover the exposed portions 31 of the teeth 30. The exposed portion 31 includes a pair of exposed end surfaces 32 and an exposed outer side surface 33.

One of the pair of exposed end surfaces 32 is located on an upper surface 30a of each of the teeth 30, and exposes the entire upper surface 30a from the corresponding insulator portion 42. The other of the pair of exposed end surfaces 32 is located on a lower surface 30b of each of the teeth 30, and exposes the entire lower surface 30b from the corresponding insulator portion 42. That is, the pair of exposed end surfaces 32 are located on respective end surfaces of the tooth 30 facing in the axial direction Z. As shown in FIG. 2, the upper surface 30a of each of the teeth 30 opposes the first rotor 10 in the axial direction Z and allows a magnetic flux to flow toward the first rotor 10. The lower surface 30b of each of the teeth 30 opposes the second rotor 20 in the axial direction Z and allows a magnetic flux to flow toward the second rotor 20. According to the present embodiment, the upper surface 30a and the lower surface 30b of each of the teeth 30 are exposed from the first resin portion 40, whereby the first resin portion 40 does not enter an air gap between the stator 60 and the pair of rotors 10 and 20, and therefore it is easy to reduce the air gap to improve torque.

As shown in FIG. 5, the exposed outer side surface 33 is continuous with one of the exposed end surfaces 32. The exposed outer side surface 33 faces a direction orthogonal to the axial direction Z. The exposed outer side surface 33 includes a first exposed surface (exposed surface) 33a facing radially outward at a radially outer end portion, a second exposed surface (exposed surface) 33b facing radially inward at a radially inner end portion, and an upper end exposed portion 33c located at an upper end portion of each of the teeth 30.

The first exposed surface 33a is provided on one surface facing radially outward and located radially outermost of the plurality of steel sheet pieces 30p. The second exposed surface 33b is provided on one surface facing radially inward and located radially innermost of the plurality of steel sheet pieces 30p. Therefore, the first exposed surface 33a and the second exposed surface 33b face opposite directions to each other. The first exposed surface 33a includes a first straight portion (straight portion) 33aa extending straight along the axial direction Z. Similarly, the second exposed surface 33b includes a second straight portion (straight portion) 33ba extending straight along the axial direction Z. In the present embodiment, the first straight portion 33aa and the second straight portion 33ba each extend from an upper end to a lower end of the steel sheet piece 30p with a uniform width dimension. Further, in the present embodiment, the width dimension of the first straight portion 33aa and the width dimension of the second straight portion 33ba are equal to each other. However, the width dimension of the first straight portion 33aa and the width dimension of the second straight portion 33ba may be different from each other.

The upper end exposed portion 33c is a surface (side surface) orthogonal to the axial direction of outer circumferential surfaces of the teeth 30 and is provided in a region continuous with the exposed end surface 32 facing upward. The upper end exposed portion 33c is configured such that a surface facing in the radial direction and a surface facing in the circumferential direction are continuous in a stepped manner. The upper end exposed portion 33c connects the first exposed surface 33a and the second exposed surface 33b.

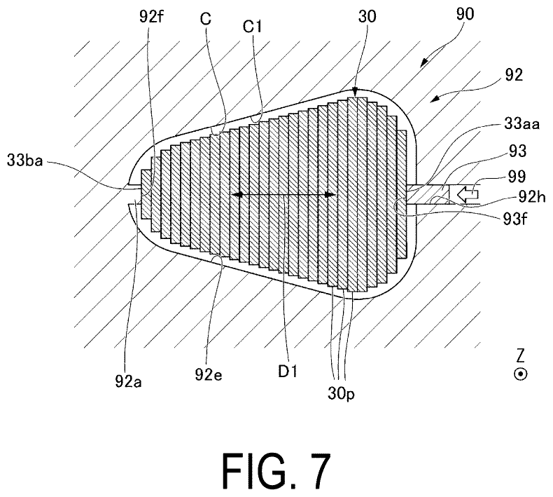

FIG. 6 is a schematic sectional view along the radial direction of a mold 90 for molding the first resin portion 40 of the present embodiment. FIG. 7 is a sectional view taken along the radial direction taken along line VII-VII of FIG. 6. FIGS. 6 and 7 illustrate each of the teeth 30 to be embedded in the first resin portion 40. FIG. 6 is a cross section of a portion slightly shifted from the circumferential center of each of the teeth 30.

As shown in FIG. 6, the mold 90 includes a first mold 91, a second mold 92, and a pressing portion 93. The first mold 91 and the second mold 92 are arranged to face each other in the axial direction Z. A cavity C is provided between the first mold 91 and the second mold 92. The mold 90 can open the cavity C to the outside by relatively moving the first mold 91 and the second mold 92 along the axial direction Z.

The cavity C includes a plurality of first spaces C1 and one second space C2. The first spaces C1 are spaces for molding the insulator portions 42 (see FIG. 4). The teeth 30 are arranged in the first spaces C1. A molten resin material flows into a gap between inner side surfaces of the first spaces C1 and the outer side surfaces of the teeth 30, is cured, and forms the insulator portions 42. The second space C2 is a space for molding the bottom wall portion 41 (see FIG. 4). The second space C2 connects the plurality of first spaces C1. Although not illustrated, the cavity C separately includes a region for molding each of the inner wall portion 43 and the outer wall portion 44 in addition to the first spaces C1 and the second space C2.

The first mold 91 of the present embodiment includes a first opposing surface 91g facing the second mold 92 side (i.e., upper side). The first opposing surface 91g is a flat surface extending along a plane orthogonal to the axial direction Z. The second mold 92 includes a second opposing surface 92g facing the first mold 91 side (i.e., lower side). The second space C2 is provided in a gap between the first opposing surface 91g and the second opposing surface 92g. The second opposing surface 92g is provided with a recess portion 92e recessed upward. The first spaces C1 are provided inside the recess portion 92e. A bottom portion of the recess portion 92e is provided with an accommodating recess portion 92d further recessed upward. That is, an inner side surface of the mold 90 is provided with the accommodating recess portion 92d. The upper end portion (end portion in the axial direction Z) of each of the teeth 30 is accommodated in the corresponding accommodating recess portion 92d. The accommodating recess portion 92d includes a bottom surface 92b facing downward and a side surface 92c extending downward from the bottom surface 92b. The side surface 92c of the accommodating recess portion 92d has a stepped shape along outer shapes of side surfaces of the teeth 30 as viewed from the axial direction Z.

In the present embodiment, in the cavity C, the lower surface 30b of each of the teeth 30 is in contact with the first opposing surface 91g, and the upper surface 30a of each of the teeth 30 is in contact with the bottom surface 92b of the accommodating recess portion 92d. That is, each of the teeth 30 in the cavity C is sandwiched between the first opposing surface 91g and the bottom surface 92b from the vertical direction. By this, the teeth 30 of the present embodiment are positioned in the axial direction Z in the cavity C. Further, the upper surface 30a and the lower surface 30b of each of the teeth 30 are in contact with the inner side surface of the mold 90, and therefore are not in contact with the molten resin material in the cavity C. Therefore, these portions are exposed from the first resin portion 40 as the exposed end surfaces 32 after the molding of the first resin portion 40.

In the present embodiment, the upper end portion of each of the teeth 30 is accommodated in the corresponding accommodating recess portion 92d. Further, an upper end portion of the side surface of each of the teeth 30 is in contact with the side surface 92c of the accommodating recess portion 92d. By this, the plurality of steel sheet pieces 30p constituting the teeth 30 are aligned in the stacking direction D1 in a state in which the central positions of the width dimensions are aligned with each other. By this, the plurality of steel sheet pieces 30p are positioned in the direction orthogonal to the axial direction Z in the cavity C. Further, the upper end portion of the side surface of each of the teeth 30 is in contact with the inner side surface of the mold 90 (more specifically, the side surface 92c of the accommodating recess portion 92d), and therefore is not in contact with the molten resin material in the cavity C. Therefore, this portion is exposed from the first resin portion 40 as the upper end exposed portion 33c (see FIG. 5) after the molding of the first resin portion 40.

The method for manufacturing the stator 60 of the present embodiment includes an arranging step of arranging the plurality of teeth 30 in the cavity C of the mold 90, and a molding step of molding the first resin portion 40. In the molding step, a molten resin material is injected into the cavity C. The injected resin material is cured, whereby the first resin portion 40 is molded. That is, the molding step is a step of filling the cavity C with resin and molding the first resin portion 40. Further, the molding step is a step of forming the insulator portion 42 on the surface of each of the teeth 30 and holding the plurality of teeth 30 by the first resin portion 40.

According to the method for manufacturing of the present embodiment, in the molding step, the plurality of insulator portions 42 are molded, and the bottom wall portion 41 connecting the plurality of insulator portions 42 is also molded. Therefore, in the molding step, the insulator portions 42 can be molded, and the plurality of teeth 30 can be relatively fixed to each other.

Further, according to the present embodiment, the insulator portions 42 are molded by insert-molding, and therefore the insulator portions 42 can be easily molded to be thin as compared with a case in which insulators molded in advance are attached to the teeth. Therefore, according to the present embodiment, as shown in FIG. 2, the space factor of coils to be mounted to the teeth 30 via the insulator portions 42 can be increased, and the magnetic characteristics of the stator 60 can be improved.

As shown in FIG. 4, each of the teeth 30 of the stator 60 manufactured by the method for manufacturing of the present embodiment is provided with the exposed portion 31 including the pair of exposed end surfaces 32 and the exposed outer side surface 33. According to the stator 60 of the present embodiment, by providing the surface of each of the teeth 30 with the pair of exposed end surfaces 32 and the exposed outer side surface 33, it is possible to bring the teeth 30 into contact with the mold 90 on the pair of exposed end surfaces 32 and the exposed outer side surface 33 during molding of the first resin portion 40. This can enhance positioning accuracy of the teeth 30 with respect to the mold 90, and can stabilize performance of the stator 60.

As shown in FIG. 6, in the arranging step and the molding step of the present embodiment, the inner side surface of the accommodating recess portion 92d of the mold 90 is in contact with the end surface (i.e., the pair of exposed end surfaces 32) facing in the axial direction Z of each of the corresponding teeth 30 and an outer side surface (i.e., the exposed outer side surface 33) continuous with the end surface and facing a direction orthogonal to the axial direction. According to the present embodiment, in the arranging step and the molding step, the teeth 30 can be held on the inner side surface of the accommodating recess portion 92d, and the plurality of teeth 30 can be positioned when insert-molding is performed. According to the method for manufacturing of the present embodiment, it is possible to form the stator 60 having excellent relative geometric tolerance between the plurality of teeth 30.

As shown in FIG. 7, the second mold 92 includes a projecting portion 92a provided on the inner side surface of each of the first spaces C1 of the cavity C and a slide accommodation portion 92h.

The projecting portion 92a projects radially outward from a radially inner end portion of the inner side surface of each of the first spaces C1. The projecting portion 92a may be located at an end portion in the stacking direction D1 of the steel sheet pieces 30p on the inner side surface of each of the first spaces C1. The projecting portion 92a of the present embodiment extends in the axial direction Z with a uniform width dimension. A tip surface of the projecting portion 92a is a flat surface orthogonal to the stacking direction D1. In the following description, the tip surface of the projecting portion 92a is referred to as a first pressing surface 92f. The first pressing surface 92f is in contact with one surface facing radially inward and located radially innermost of the plurality of steel sheet pieces 30p constituting the teeth 30 arranged in the cavity C.

The slide accommodation portion 92h is recessed radially outward from a radially outer end portion of the inner side surface of each of the first spaces C1. The slide accommodation portion 92h may be located at an end portion in the stacking direction D1 on the opposite side of the projecting portion 92a on the inner side surface of each of the first spaces C1. The slide accommodation portion 92h of the present embodiment extends in a groove shape in the axial direction Z with a uniform width dimension.

The pressing portion 93 is a quadrangular prism block extending along the axial direction Z. The pressing portion 93 is accommodated in the slide accommodation portion 92h. A tip portion of the pressing portion 93 projects radially inward from the slide accommodation portion 92h. A tip surface of the pressing portion 93 is a flat surface orthogonal to the stacking direction D1. In the following description, the tip surface of the pressing portion 93 is referred to as a second pressing surface 93f. The second pressing surface 93f is in contact with one surface facing radially outward and located radially outermost of the plurality of steel sheet pieces 30p constituting the teeth 30 arranged in the cavity C.

The pressing portion 93 is in contact with the inner side surface of the slide accommodation portion 92h and is movable in the radial direction (i.e., the stacking direction D1). Inside the slide accommodation portion 92h, a pressing mechanism 99 that applies stress to a radially outer end surface of the pressing portion 93 is provided. The pressing mechanism 99 may be, for example, a hydraulic mechanism or a spring. The pressing portion 93 presses the second pressing surface 93f radially outward of the teeth 30 by the action of the pressing mechanism 99.

The inner side surface of the mold 90 of the present embodiment is provided with a pair of the pressing surfaces 92f and 93f in contact with the end surfaces on one side and the other side in the stacking direction D1 of each of the teeth 30. According to the molding step of the present embodiment, the first resin portion 40 is insert-molded while the end surfaces on one side and the other side in the stacking direction D1 of each of the teeth 30 are supported by the pair of pressing surfaces 92f and 93f. According to the present embodiment, it is possible to suppress generation of a gap in the plurality of stacked steel sheet pieces 30p in the cavity C, and it is possible to suppress intrusion of a resin material in a molten state between the plurality of stacked steel sheet pieces 30p.

The mold 90 of the present embodiment can hold the plurality of steel sheet pieces 30p in the cavity C by the pair of pressing surfaces 92f and 93f. In general, in a known method for manufacturing, teeth are arranged in a cavity after a preliminary step of fixing a plurality of steel sheet pieces to each other by caulking, welding, or the like is performed. On the other hand, according to the present embodiment, since the mold 90 holds the plurality of steel sheet pieces 30p without any gap, the preliminary step can be omitted. That is, according to the present embodiment, the plurality of steel sheet pieces 30p can be fixed to each other only by the first resin portion 40, and the manufacturing process of the stator 60 can be simplified. According to the present embodiment, since it is not necessary to perform caulking or welding on the steel sheet pieces 30p, it is possible to suppress deterioration of magnetic characteristics of the steel sheet pieces 30p due to caulking or welding.

As shown in FIG. 5, each of the teeth 30 of the stator 60 manufactured by the method for manufacturing of the present embodiment includes a pair of the exposed surfaces (the first exposed surface 33a and the second exposed surface 33b) provided on the end surfaces on one side and the other side in the stacking direction D1 as traces of the pair of pressing surfaces 92f and 93f. According to the stator 60 of the present embodiment, by providing the surface of each of the teeth 30 with the first exposed surface 33a and the second exposed surface 33b, it is possible to bring the teeth 30 into contact with the mold 90 at both end surfaces in the stacking direction D1 of the plurality of steel sheet pieces 30p during molding of the first resin portion 40. This can suppress generation of a gap between the plurality of steel sheet pieces 30p. Further, it is possible to configure the stator 60 fixing the steel sheet pieces 30p to each other without performing caulking, and it is possible to enhance magnetic performance of the stator 60.

As shown in FIG. 7, the mold 90 of the present embodiment includes the pressing portion 93 movable in the stacking direction D1. The pressing portion 93 is arranged on a surface facing in the stacking direction D1 of the inner side surface surrounding the cavity C of the mold 90. The pressing portion 93 includes the first pressing surface 92f, which is one pressing surface, and presses the teeth 30 against the second pressing surface 93f, which is the other pressing surface. According to the present embodiment, in a case in which the steel sheet pieces 30p are not fixed by caulking or the like, insert-molding is performed while an appropriate pressure is applied by the movable pressing portion, whereby entry of the resin between the steel sheet pieces 30p is suppressed more easily. Further, according to the present embodiment, the steel sheet pieces 30p are easily fixed to the mold 90 as compared with a case in which only a non-movable pressing portion is included, and therefore even in a case in which dimension accuracy of the mold 90 is low, it is possible to suppress intrusion of the resin material between the steel sheet pieces 30p. Therefore, the mold 90 can be manufactured at low cost, and the manufacturing cost of the stator 60 can be reduced.

As shown in FIG. 5, the first exposed surface 33a of the stator 60 manufactured by the method for manufacturing of the present embodiment is provided with the first straight portion 33aa, and the second exposed surface 33b is provided with the second straight portion 33ba. The first straight portion 33aa is a trace of contact of the second pressing surface 93f during molding of the first resin portion 40. Similarly, the second straight portion 33ba is a trace of contact of the first pressing surface 92f during molding of the first resin portion 40. According to the stator 60 of the present embodiment, by providing the end surface in the stacking direction D1 of each of the teeth 30 with the first straight portion 33aa and the second straight portion 33ba extending along the axial direction Z, it is possible to bring the pressing surfaces 92f and 93f extending along the axial direction Z into contact at both end surfaces in the stacking direction D1 of the plurality of steel sheet pieces 30p during molding of the first resin portion 40. This can press the entire region in the axial direction Z of the steel sheet pieces 30p in the stacking direction D1 on the inner side surface of the mold 90, and can more reliably suppress generation of a gap between the steel sheet pieces 30p.

The shapes of the first straight portion 33aa and the second straight portion 33ba are shapes in which the shapes of the first pressing surface 92f and the second pressing surface 93f, respectively, are transferred. Therefore, the shapes of the first straight portion 33aa and the second straight portion 33ba can be freely changed by changing the shapes of the first pressing surface 92f and the second pressing surface 93f. The shapes of the first straight portion 33aa and the second straight portion 33ba may be changed within a range in which the plurality of steel sheet pieces 30p can be sufficiently suppressed in the stacking direction D1, contact of the teeth 30 with the coils 63 is suppressed as the insulator portions 42, and mold releasability from the mold 90 can be secured. Further, the shapes of the first straight portion 33aa and the second straight portion 33ba need not be straight, may be a trapezoidal shape in which the width increases toward the upper side or the lower side, or may be a shape interrupted in the axial direction Z without reaching the upper end portion.

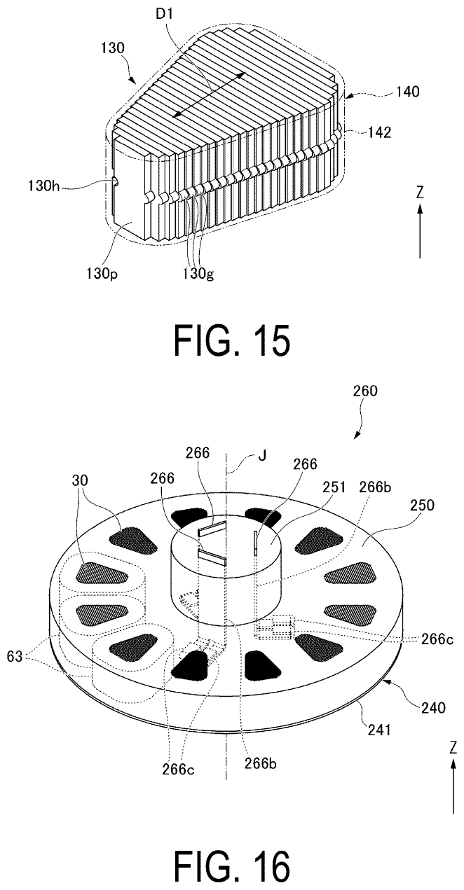

As shown in FIG. 5, in the present embodiment, the width dimension of the first straight portion 33aa is preferably smaller than the width dimension of one of the steel sheet pieces 30p located at a radially outer end portion among the plurality of steel sheet pieces 30p constituting the teeth 30. Similarly, the width dimension of the second straight portion 33ba is preferably smaller than the width dimension of one of the steel sheet pieces 30p located at a radially inner end portion among the plurality of steel sheet pieces 30p constituting the teeth 30. By this, a circumferential end portion of a surface facing in the stacking direction of the steel sheet piece 30p located at the end portion in the radial direction can be covered with the first resin portion 40, and detachment of the steel sheet pieces 30p from the teeth 30 can be suppressed. By covering the circumferential end portion of the steel sheet piece 30p of the end portion with the first resin portion 40, it is easy for the first resin portion 40 to suppress direct contact between the steel sheet pieces 30p at the end portion and the coils 63. In addition, according to the present embodiment, by covering the circumferential end portion of the steel sheet piece 30p of the end portion with the first resin portion 40, the molten resin material easily surrounds the side surface of each of the teeth 30 along an outer circumference of each of the teeth 30 in the cavity C. This enables the insulator portions 42 having a uniform thickness to be stably molded. This effect is more remarkable in a case in which the outer circumference of each of the teeth 30 is provided with a protrusion portion 130g (see FIG. 15 described later as a modification).

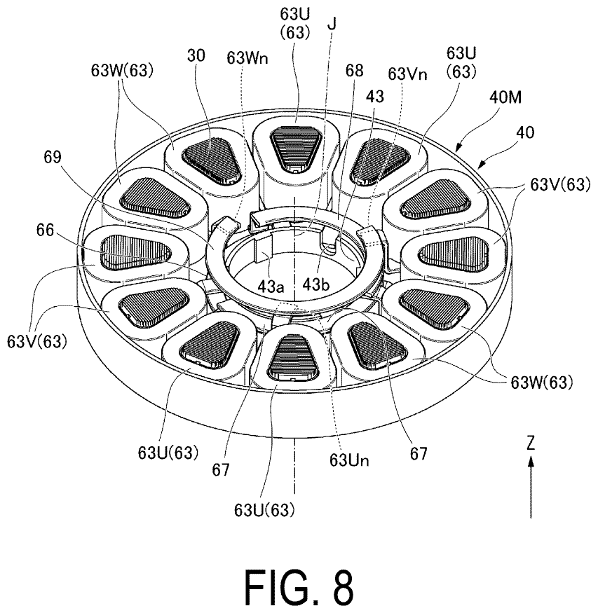

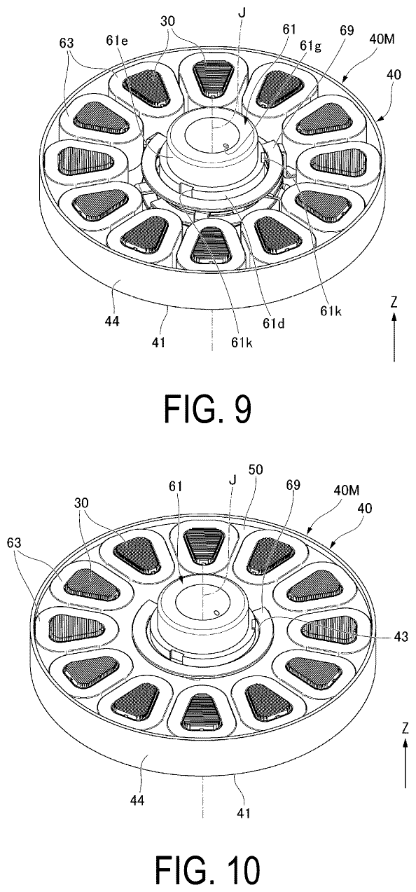

FIGS. 8 to 10 are perspective views showing the step of assembling each component to the molded component 40M. FIG. 8 shows a state in which the plurality of coils 63 and the plurality of busbars 66, 67, 68, and 69 are mounted to the molded component 40M, FIG. 9 shows a state in which the shaft 61 is further mounted, and FIG. 10 shows a state in which the second resin portion 50 is further molded.

As shown in FIG. 8, the coils 63 are mounted to the plurality of respective teeth. The coil 63 of the present embodiment is constituted by, for example, a strip-shaped coil wire having the axial direction Z as a thickness direction. The strip-shaped coil wire extends spirally along the outer circumference of each of the teeth 30.

The stator 60 of the present embodiment is provided with twelve coils 63. The twelve coils 63 are classified into four U-phase coils 63U, four V-phase coils 63V, and four W-phase coils 63W. That is, the plurality of coils 63 are classified into multi-phase coils 63. Alternating current of the same phase flows through the plurality of in-phase coils 63. Further, alternating currents flowing through the coils 63 of different phases are out of phase with each other. In the U-phase coils 63U, the V-phase coils 63V, and the W-phase coils 63W of the present embodiment, alternating currents of which the phase is shifted by 120° flow. The number of coils 63 of each phase is not limited to the number in the present embodiment.

Each of the plurality of busbars 66, 67, 68, and 69 has a plate shape having the axial direction Z as a thickness direction. Each of the plurality of busbars 66, 67, 68, and 69 has a strip shape having the radial direction as a width direction, and extends in an arc shape along the circumferential direction. The three busbars 66, 67, and 68 for connection of the present embodiment have the same shape as each other. Further, the busbar 69 for neutral point is larger in length dimension in the circumferential direction than the busbars 66, 67, and 68 for connection.

Each of the plurality of busbars 66, 67, 68, and 69 connects the coils 63. The plurality of busbars 66, 67, 68, and 69 of the present embodiment include the three busbars 66, 67, and 68 for connection connecting the in-phase coils 63, and the one busbar 69 for neutral point connecting the three-phase coils 63. Further, the three busbars 66, 67, and 68 for connection include the busbar 66 for U-phase connection, the busbar 67 for V-phase connection, and the busbar 68 for W-phase connection. In the present embodiment, the plurality of busbars 66, 67, 68, and 69 connect the plurality of coils 63 to constitute a Y connection. Further, as shown in FIG. 2, power supply lines 62 through which alternating current flows to the coils 63 of respective phases are connected to the U-phase coils 63U, the V-phase coils 63V, and the W-phase coils 63W. That is, the stator 60 includes the three power supply lines 62. Each of the power supply lines 62 is connected to an external power supply.

The plurality of busbars 66, 67, 68, and 69 are arranged side by side at intervals along the axial direction Z. According to the present embodiment, the plurality of busbars 66, 67, 68, and 69 overlap each other as viewed from the axial direction Z. According to the present embodiment, as viewed from the axial direction Z, the plurality of busbars 66, 67, 68, and 69 can be arranged in a concentrated manner, and the radial dimension of the stator 60 can be reduced. Further, since each of the plurality of busbars 66, 67, 68, and 69 of the present embodiment has a plate shape having the axial direction Z as a thickness direction, it is possible to suppress an increase in size in the axial direction Z of the stator 60 in a case of being arranged to overlap in the axial direction Z.

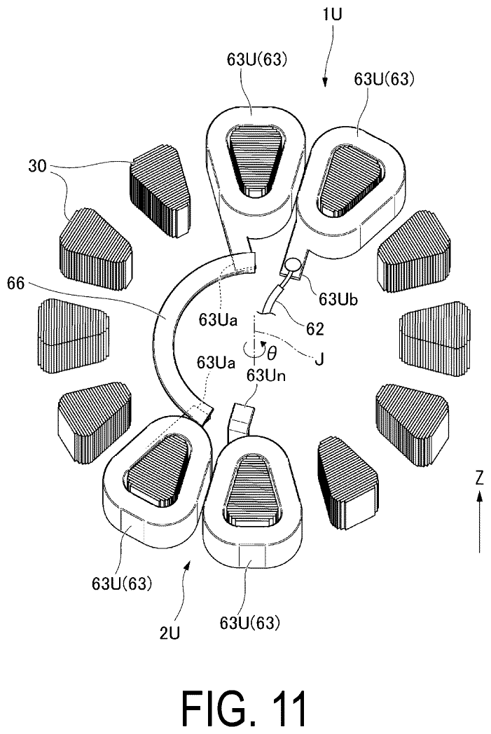

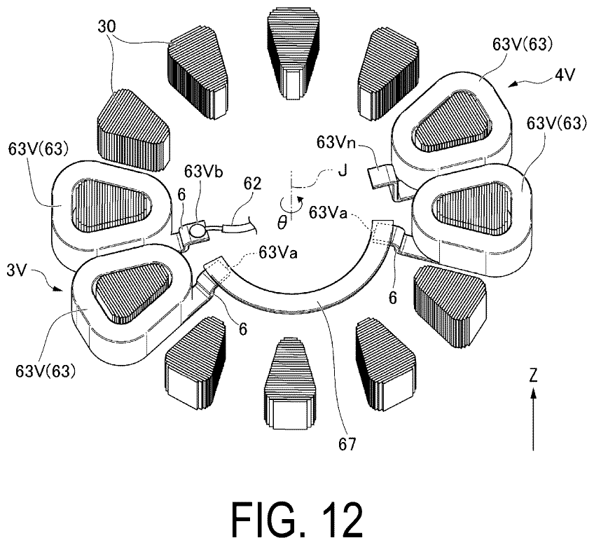

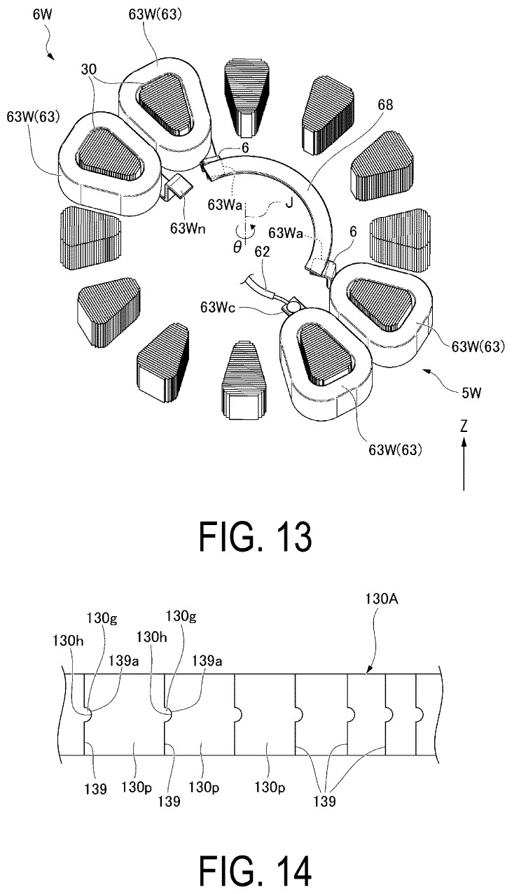

FIG. 11 is a perspective view showing the plurality of teeth 30, the busbar 66 for U-phase connection, and the plurality of U-phase coils 63U of the present embodiment. FIG. 12 is a perspective view showing the plurality of teeth 30, the busbar 67 for V-phase connection, and the plurality of V-phase coils 63V of the present embodiment. FIG. 13 is a perspective view showing the plurality of teeth 30, the busbar 68 for W-phase connection, and the plurality of W-phase coils 63W of the present embodiment. FIGS. 11 to 13 illustrate a circumferential direction θ around the center axis J. In the following description, a direction in which an arrow indicating the circumferential direction θ in the drawing faces is referred to as one circumferential side (+θ), and the opposite side is referred to as an other circumferential side (−θ).

As shown in FIG. 11, the four U-phase coils 63U of the present embodiment are divided into two sets (a first set 1U and a second set 2U) including the two U-phase coils 63U. The U-phase coils 63U of the same set are mounted to the teeth 30 adjacent to each other in the circumferential direction. Further, the four teeth 30 for mounting the coils 63 of other phases are arranged between the U-phase coils 63U of different sets from each other in the circumferential direction. The U-phase coils 63U of the same set adjacent to each other in the circumferential direction are connected to each other at crossover portions not illustrated. Further, the U-phase coils 63U of different sets are connected by the busbar 66 for U-phase connection.

The U-phase coil 63U located on one circumferential side (+θ) of the U-phase coils 63U of the first set 1U and the U-phase coil 63U located on the other circumferential side (−θ) of the U-phase coils 63U of the second set 2U each include a first connection portion 63Ua. The first connection portions 63Ua extend radially inward from the U-phase coils 63U. The busbar 66 for U-phase connection is connected to an upper surface of a tip portion of the first connection portion 63Ua. By this, the two sets of U-phase coils 63U are connected to each other. The first connection portion 63Ua and the busbar 66 for U-phase connection are electrically connected by means such as resistance welding.

The U-phase coil 63U located on the other circumferential side (−θ) of the U-phase coils 63U of the first set 1U includes a second connection portion 63Ub. The second connection portion 63Ub extends radially inward from the U-phase coil 63U. The power supply line 62 to be connected to the external power supply is connected to an upper surface of a tip portion of the second connection portion 63Ub. The second connection portion 63Ub and the power supply line 62 are electrically connected by means such as resistance welding, for example.

The U-phase coil 63U located on one circumferential side (+θ) of the U-phase coils 63U of the second set 2U includes a third connection portion 63Un. The third connection portion 63Un extends radially inward from the U-phase coil 63U. The busbar 69 for neutral point is connected to an upper surface of a tip portion of the third connection portion 63Un. By this, the third connection portion 63Un of the U-phase coils 63U is connected to the third connection portion of another phase. The third connection portion 63Un and the busbar 69 for neutral point are electrically connected by means such as resistance welding.

As shown in FIG. 12, the four V-phase coils 63V of the present embodiment are divided into two sets (a third set 3V and a fourth set 4V) including the two V-phase coils 63V. The V-phase coils 63V of the same set are mounted to the teeth 30 adjacent to each other in the circumferential direction. Further, the four teeth 30 for mounting the coils 63 of other phases are arranged between the V-phase coils 63V of different sets from each other in the circumferential direction. The V-phase coils 63V of the same set adjacent to each other in the circumferential direction are connected to each other at crossover portions not illustrated. Further, the V-phase coils 63V of different sets are connected by the busbar 67 for V-phase connection.

The V-phase coil 63V located on one circumferential side (+θ) of the V-phase coils 63V of the third set 3V and the V-phase coil 63V located on the other circumferential side (−θ) of the V-phase coils 63V of the fourth set 4V each include a first connection portion 63Va. The first connection portions 63Va extend radially inward from the V-phase coils 63V. The busbar 67 for V-phase connection is connected to an upper surface of a tip portion of the first connection portion 63Va. By this, the two sets of V-phase coils 63V are connected to each other. The first connection portion 63Va and the busbar 67 for V-phase connection are electrically connected by means such as resistance welding.

The V-phase coil 63V located on the other circumferential side (−θ) of the V-phase coils 63V of the third set 3V includes a second connection portion 63Vb. The second connection portion 63Vb extends radially inward from the V-phase coil 63V. The power supply line 62 to be connected to the external power supply is connected to an upper surface of a tip portion of the second connection portion 63Vb. The second connection portion 63Vb and the power supply line 62 are electrically connected by means such as resistance welding, for example.

The V-phase coil 63V located on one circumferential side (+θ) of the V-phase coils 63V of the fourth set 4V includes a third connection portion 63Vn. The third connection portion 63Vn extends radially inward from the V-phase coil 63V. The busbar 69 for neutral point is connected to an upper surface of a tip portion of the third connection portion 63Vn. By this, the third connection portion 63Vn of the V-phase coils 63V is connected to the third connection portion of another phase. The third connection portion 63Vn and the busbar 69 for neutral point are electrically connected by means such as resistance welding.

As shown in FIG. 13, the four W-phase coils 63W of the present embodiment are divided into two sets (a fifth set 5W and a sixth set 6W) including the two W-phase coils 63W. The W-phase coils 63W of the same set are mounted to the teeth 30 adjacent to each other in the circumferential direction. Further, the four teeth 30 for mounting the coils 63 of other phases are arranged between the W-phase coils 63W of different sets from each other in the circumferential direction. The W-phase coils 63W of the same set adjacent to each other in the circumferential direction are connected to each other at crossover portions not illustrated. Further, the W-phase coils 63W of different sets are connected by the busbar 68 for W-phase connection.

The W-phase coil 63W located on one circumferential side (+θ) of the W-phase coils 63W of the fifth set 5W and the W-phase coil 63W located on the other circumferential side (−θ) of the W-phase coils 63W of the sixth set 6W each include a first connection portion 63Wa. The first connection portions 63Wa extend radially inward from the W-phase coils 63W. The busbar 68 for W-phase connection is connected to an upper surface of a tip portion of the first connection portion 63Wa. By this, the two sets of W-phase coils 63W are connected to each other. The first connection portion 63Wa and the busbar 68 for W-phase connection are electrically connected by means such as resistance welding.

The W-phase coil 63W located on the other circumferential side (−θ) of the W-phase coils 63W of the fifth set 5W includes a second connection portion 63Wc. The second connection portion 63Wc extends radially inward from the W-phase coil 63W. The power supply line 62 to be connected to the external power supply is connected to an upper surface of a tip portion of the second connection portion 63Wc. The second connection portion 63Wc and the power supply line 62 are electrically connected by means such as resistance welding, for example.

The W-phase coil 63W located on one circumferential side (+θ) of the W-phase coils 63W of the sixth set 6W includes a third connection portion 63Wn. The third connection portion 63Wn extends radially inward from the W-phase coil 63W. The busbar 69 for neutral point is connected to an upper surface of a tip portion of the third connection portion 63Wn. By this, the third connection portion 63Wn of the W-phase coils 63W is connected to the third connection portion of another phase. The third connection portion 63Wn and the busbar 69 for neutral point are electrically connected by means such as resistance welding.

As described above, in the present embodiment, some (six in the present embodiment) of the plurality of coils 63 include the first connection portions 63Ua, 63Va, and 63Wa to be connected to the busbars 66, 67, and 68 for connection. Some (three in the present embodiment) of the plurality of coils 63 include the second connection portions 63Ub, 63Vb, and 63Wc to be connected to the power supply line 62. Some (three in the present embodiment) of the plurality of coils 63 include the third connection portions 63Un, 63Vn, and 63Wn to be connected to the busbar 69 for neutral point.

As shown in FIG. 11, the two first connection portions 63Ua to be connected by the busbar 66 for U-phase connection are arranged at the same height. As shown in FIG. 12, the two first connection portions 63Va to be connected by the busbar 67 for V-phase connection are arranged at the same height. As shown in FIG. 13, the two first connection portions 63Wa to be connected by the busbar 68 for W-phase connection are arranged at the same height. That is, the in-phase first connection portions 63Ua, 63Va, and 63Wa to be connected by any one of the busbars 66, 67, and 68 for connection have axial positions coinciding with each other. According to the present embodiment, the busbars 66, 67, and 68 for connection can be arranged along a plane orthogonal to the center axis J over the entire length. That is, it is not necessary to provide the busbars 66, 67, and 68 for connection with portions bent in the axial direction Z, and it is possible to simplify the structures of the busbars 66, 67, and 68 for connection. Further, according to the present embodiment, the busbars 66, 67, and 68 for connection are supported by the first connection portions 63Ua, 63Va, and 63Wa having the same height at both end portions, and therefore it is not necessary to separately prepare a structure for supporting the busbars 66, 67, and 68 for connection. Therefore, it is possible to simplify the structure around the busbars 66, 67, and 68 for connection in the stator 60.

As shown in FIG. 11, the two U-phase first connection portions 63Ua of the present embodiment extend straight from lower end portions of the coils 63. That is, the U-phase first connection portion 63Ua does not include a bent portion bent in the axial direction Z, and the processing cost of the connection portion can be suppressed. On the other hand, as shown in FIGS. 12 and 13, the V-phase and W-phase first connection portions 63Va and 63Wa of the present embodiment each include a bent portion 6 bent in the axial direction Z. The positions in the circumferential direction θ of the V-phase and W-phase first connection portions 63Va and 63Wa overlap a region in which the busbar 66 for U-phase connection extends in the circumferential direction θ. Further, the busbar 66 for U-phase connection is connected to the U-phase first connection portion 63Ua extending from the lower end portion of the coil 63, and therefore is arranged in the vicinity of the position in the axial direction Z of the lower end portion of the coil 63 in the axial direction Z. By providing the bent portion 6, the V-phase and W-phase first connection portions 63Va and 63Wa are arranged above the busbar 66 for U-phase connection at the radially inner end portion. Since each of the V-phase and W-phase first connection portions 63Va and 63Wa of the present embodiment includes the bent portion 6, interference with the busbar 66 for U-phase connection is suppressed.

As shown in FIGS. 11 and 13, the U-phase second connection portion 63Ub and the W-phase second connection portion 63Wc of the present embodiment extend straight from the lower end portions of the coils 63. That is, each of the U-phase and W-phase second connection portions 63Ub and 63Wc does not include a bent portion in the axial direction Z, and the processing cost of the connection portion can be suppressed. The U-phase and W-phase second connection portions 63Ub and 63Wc are arranged at positions shifted in the circumferential direction θ with respect to the region in which the busbar 66 for U-phase connection extends in the circumferential direction θ. Therefore, even if the U-phase and W-phase second connection portions 63Ub and 63Wc do not include the bent portion, there is no concern about interference with the busbar 66 for U-phase connection. On the other hand, as shown in FIG. 12, the V-phase second connection portion 63Vb of the present embodiment includes the bent portion 6 bent in the axial direction Z. The position in the circumferential direction θ of the V-phase second connection portion 63Vb overlaps the region in which the busbar 66 for U-phase connection extends in the circumferential direction θ. The V-phase second connection portion 63Vb is arranged above the busbar 66 for U-phase connection at the radially inner end portion. Since each of the V-phase second connection portions 63Vb of the present embodiment includes the bent portion 6, interference with the busbar 66 for U-phase connection is suppressed.

As described above, according to the stator 60 of the present embodiment, the positions in the axial direction Z of at least one first connection portion (the U-phase first connection portion 63Ua in the present embodiment) of the plurality of first connection portions 63Ua, 63Va, and 63Wa and at least one second connection portion (the U-phase and W-phase second connection portions 63Ub and 63Wc in the present embodiment) of the plurality of second connection portions 63Ub, 63Vb, and 63Wc coincide with the positions in the axial direction Z of the lower end portions of the coils 63. According to the present embodiment, it is not necessary to provide the first connection portion 63Ua and the second connection portions 63Ub and 63Wc with bent portions, and it is possible to reduce the processing cost of the connection portions.

As shown in FIG. 9, the shaft 61 is a hollow shaft extending in the axial direction Z around the center axis J. The shaft 61 is located radially inward of the plurality of teeth 30 and the plurality of busbars 66, 67, 68, and 69. The shaft 61 of the present embodiment is made of metal. Examples of the metal material constituting the shaft 61 include steel such as stainless steel and an aluminum alloy.

The shaft 61 of the present embodiment includes a hollow portion 61h and a plurality of hole portions 61g. The hollow portion 61h extends in the axial direction Z around the center axis J and opens at an upper end portion and a lower end portion of the shaft 61. The hole portions 61g extend radially outward from the hollow portion 61h and open on the outer circumferential surface of the shaft 61. In the shaft 61 of the present embodiment, the three hole portions 61g are arranged at equal intervals along the circumferential direction.

As shown in FIG. 2, the outer circumferential surface of the shaft 61 is provided with a large-diameter portion 61d and two small-diameter portions 61e. The two small-diameter portions 61e are located above and below the large-diameter portion 61d. The outer circumferential surface of the shaft 61 has a diameter smaller than that of the large-diameter portion 61d in the two small-diameter portions 61e. The inner rings of the bearings 17 and 27 are fitted into the two small-diameter portions 61e, respectively. Further, the inner wall portion 43 of the first resin portion 40 is fitted into the large-diameter portion 61d. The large-diameter portion 61d and the inner wall portion 43 are fixed to each other by a fixing means such as an adhesive.

The hole portions 61g open radially outward in the large-diameter portion 61d of the shaft 61. The power supply line 62 is passed through the hole portion 61g. The stator 60 of the present embodiment is provided with three power supply lines 62 of the U-phase, the V-phase, and the W-phase. One power supply line 62 of each phase is passed through a corresponding one of the three hole portions 61g.

In the present embodiment, the plurality of hole portions 61g are arranged to overlap a range R in the axial direction Z in which the plurality of busbars 66, 67, 68, and 69 are arranged. This enables the power supply lines 62 to be connected to the second connection portions 63Ub, 63Vb, and 63Wc of the coils 63 in the range R in the axial direction Z in which the plurality of busbars 66, 67, 68, and 69 are arranged, and the stator 60 can be downsized in the axial direction Z as compared with a case of separately providing a region through which the power supply line 62 is passed.

As shown in FIG. 9, the hole portion 61g overlaps the notch portion 43b of the inner wall portion 43 as viewed from the radial direction. This suppresses blockage of the openings of the hole portions 61g by the inner wall portion 43. Further, the large-diameter portion 61d is provided with a recessed groove 61k extending along the axial direction Z. The outer circumferential surface of the shaft 61 of the present embodiment is provided with three recessed grooves 61k. The three recessed grooves 61k are arranged at equal intervals along the circumferential direction. The anti-rotation portion 43a of the inner wall portion 43 shown in FIG. 8 is inserted into the recessed groove 61k. A part of an outer side surface of the anti-rotation portion 43a and a part of an inner circumferential surface of the recessed groove 61k oppose each other in the circumferential direction. This suppresses relative rotation of the shaft 61 with respect to the first resin portion 40.

As shown in FIG. 10, the second resin portion 50 covers at least a part of the plurality of coils 63. Further, as shown in FIG. 2, the second resin portion 50 covers at least a part of the busbars 66, 67, 68, and 69. The second resin portion 50 of the present embodiment is an insulating potting material. The second resin portion 50 may be an adhesive. The second resin portion 50 is filled and cured in a region surrounded by the outer wall portion 44, the inner wall portion 43, and the bottom wall portion 41 of the first resin portion 40 in an uncured state. When a potting step is performed, the hole portions 61g of the shaft 61 are blocked in advance.

The thermal conductivity of the material constituting the second resin portion 50 of the present embodiment is preferably higher than the thermal conductivity of the material constituting the first resin portion 40. By using a material having high thermal conductivity as a material constituting the second resin portion 50, heat is absorbed from the coils 63 and the busbars 66, 67, 68, and 69 embedded by the second resin portion 50, and is dissipated to the atmosphere or another member. This enables the second resin portion 50 to cool the coils 63 and the busbars 66, 67, 68, and 69.

In the first resin portion 40 of the present embodiment, an upper end portion of the inner wall portion 43 is located below an upper end portion of the outer wall portion 44. Further, the shaft 61 is inserted into the inner circumferential surface of the inner wall portion 43. The second resin portion 50 is filled up to the upper end portion of the outer wall portion 44. Therefore, the second resin portion 50 of the present embodiment is in contact with the outer circumferential surface of the shaft 61 made of metal. The second resin portion 50 can transfer the heat of the coils 63 and the busbars 66, 67, 68, and 69 to the shaft 61 having a large heat capacity and dissipate the heat from the shaft 61 to the outside air. This enables the second resin portion 50 to efficiently cool the coils 63 and the busbars 66, 67, 68, and 69.

As a material constituting the second resin portion 50, it is preferable to adopt an appropriate resin material in consideration of high thermal conductivity, viscosity, and the like. Further, a filler for increasing the thermal conductivity may be blended in the material constituting the second resin portion 50.

<Method for Manufacturing Stator> Next, a method for manufacturing the stator 60 of the present embodiment will be described.

The method for manufacturing the stator 60 includes a steel sheet cutting step, the arranging step, the molding step, a mounting step, and a filling step. In the method for manufacturing the stator 60 of the present embodiment, the steel sheet cutting step, the arranging step, the molding step, the mounting step, and the filling step are performed in this order.

The steel sheet cutting step is a step of manufacturing the plurality of steel sheet pieces 30p as shown in FIG. 5. Each of the plurality of steel sheet pieces 30p used for one tooth 30 has a rectangular plate shape. The plurality of steel sheet pieces 30p have the same sheet thickness and the same dimension in the axial direction Z. On the other hand, the plurality of steel sheet pieces 30p have different width dimensions along the circumferential direction. In the steel sheet cutting step of the present embodiment, the plurality of steel sheet pieces 30p are formed by cutting a steel sheet having a strip shape. In the steel sheet cutting step of the present embodiment, the steel sheet pieces 30p are formed by repeatedly cutting the steel sheet having a strip shape in the length direction of the steel sheet along straight cutting lines.

According to the steel sheet cutting step of the present embodiment, the plurality of types of steel sheet pieces 30p used for one tooth 30 can be easily manufactured by changing the interval between the cutting lines. That is, according to the steel sheet cutting step of the present embodiment, the plurality of rectangular steel sheet pieces 30p having different width dimensions can be easily manufactured. According to the steel sheet cutting step of the present embodiment, offcuts of the steel sheet are not generated during manufacturing, and the yield of the steel sheet can be increased, as compared with a case in which the steel sheets are stacked by press working.

The steel sheet cutting step will be described in more detail later with reference to FIG. 14 showing a steel sheet cutting step of the modification.

As shown in FIG. 6, the arranging step is a step of arranging the plurality of teeth 30 in the respective first spaces C1 of the cavity C. As described above, in the present embodiment, the plurality of steel sheet pieces 30p are not fixed in advance by caulking, welding, or the like. Therefore, in the arranging step, the plurality of steel sheet pieces 30p are stacked in the stacking direction D1, arranged in the cavity C, and supported by the mold 90. In the present embodiment, the plurality of steel sheet pieces 30p are held by the pair of pressing surfaces 92f and 93f.

The molding step is a step of filling the cavity C with resin to manufacture the molded component 40M (see FIG. 4). In the cavity C shown in FIG. 6, the first spaces C1 for forming the insulator portions 42 are connected to each other via the second space C2 for molding the bottom wall portion 41. Therefore, the plurality of insulator portions 42 molded through the molding step are connected to each other by the bottom wall portion 41. Further, the insulator portions 42 hold the respective teeth 30. Therefore, the plurality of teeth 30 are fixed to each other through the molding step.

The mounting step is a step of mounting the coils 63, the busbars 66, 67, 68, and 69, and the shaft 61 to the molded component 40M. As shown in FIG. 8, in the mounting step, the coils 63 are mounted to the teeth 30 via the insulator portions 42. The coils 63 of the present embodiment are inserted into the teeth 30 in a state of being molded in a spiral shape in advance. Further, in the mounting step, the busbars 66, 67, 68, and 69 are joined to the coils using a joining means such as welding. As shown in FIG. 9, in the mounting step, the shaft 61 is fixed to the first resin portion 40. The shaft 61 may be embedded in the first resin portion 40 together with the plurality of teeth 30 by insert-molding.

The filling step is a step of molding the second resin portion 50 by filling the potting material in an uncured state into a region surrounded by the outer wall portion 44, the inner wall portion 43, and the bottom wall portion 41 of the first resin portion 40 and curing the potting material. In a case in which the second resin portion 50 is made of an ultraviolet-curable resin, the filled second resin portion 50 is irradiated with ultraviolet rays.

Through the above steps, the stator 60 of the present embodiment is manufactured.

<Modification> A steel sheet cutting step of the modification that can be adopted in the first embodiment and teeth 130 of the modification manufactured through the steel sheet cutting step will be described.

FIG. 14 is a schematic view showing a steel sheet cutting step according to the present modification.

Similarly to the above-described embodiment, the steel sheet cutting step is a step that is performed before the arranging step, and that is for manufacturing a plurality of steel sheet pieces 130p. Similarly to the above-described embodiment, the steel sheet cutting step is a step of cutting a steel sheet 130A having a strip shape along a cutting line 139 extending along a width direction to form the plurality of steel sheet pieces 130p. According to such a steel sheet cutting step, the plurality of rectangular steel sheet pieces 130p can be easily manufactured, and the yield of the steel sheet can be increased.

In the steel sheet cutting step, a cutting blade having the same shape as the cutting line 139 is used. In the steel sheet cutting step, the cutting blade is pressed in a thickness direction of the steel sheet 130A having a strip shape against the steel sheet 130A unwound from a roll, thereby cutting the steel sheet 130A. In the steel sheet cutting step, a feed amount of the steel sheet 130A having a strip shape is adjusted, thereby changing a distance between the cutting lines 139 with respect to a length direction of the steel sheet 130A.

In the present modification, the cutting line 139 has a protruding shape 139a projecting to one side in the length direction of the steel sheet 130A having a strip shape. That is, in the present modification, the cutting blade for cutting the steel sheet 130A has a protruding shape projecting to one side in the length direction of the steel sheet 130A. The cutting line 139 has the protruding shape 139a, whereby the protrusion portion 130g is provided on one edge located on one side in the length direction of the formed steel sheet piece 130p, and a recess portion 130h is provided on one edge located on the other side in the length direction.

FIG. 15 is a perspective view of each of the teeth 130 of the present modification. The steel sheet pieces 130p formed through the cutting step of the present modification are stacked in the stacking direction D1 in the arranging step, and covered with the insulator portion 142 of the first resin portion 140 in the molding step. The protrusion portion 130g and the recess portion 130h of the steel sheet piece 130p are arranged on surfaces facing one side and the other side in the circumferential direction of each of the teeth 130.

A projection height of the protrusion portion 130g is sufficiently small with respect to a thickness dimension of the insulator portion 142. The protrusion portion 130g is entirely embedded in the insulator portion 142. By this, the insulator portion 142 ensures insulation between the protrusion portion 130g and the coil 63. Further, a part of the insulator portion 142 enters the recess portion 130h.

According to the present embodiment, the protrusion portion 130g is embedded in the insulator portion 142, thereby opposing a part of the insulator portion 142 in the axial direction Z. Similarly, due to entry of a part of the insulator portion 142, the recess portion 130h opposes, in the axial direction Z, a part of the insulator portion 142 on an inside surface. Therefore, the protrusion portion 130g and the recess portion 130h function as retaining portions that suppress movement of each of the teeth 130 in the axial direction Z with respect to the insulator portion 142. That is, a surface of each of the teeth 130 is provided with the retaining portion including at least the protrusion portion 130g or the recess portion 130h. According to the present modification, the teeth 130 and the first resin portion 140 can be fixed with a simple structure.

In the present modification, a case in which the surface of each of the teeth 130 is provided with both the protrusion portion 130g and the recess portion 130h as the retaining portions has been described. However, the retaining portion may include only one of the protrusion portion 130g and the recess portion 130h. Further, the retaining portion may include a plurality of the protrusion portions 130g or a plurality of the recess portions 130h.

In the present modification, a case in which all the steel sheet pieces 130p constituting the teeth 130 are provided with the retaining portions (the protrusion portions 130g or the recess portions 130h) has been described. In this case, even if all the steel sheet pieces 130p are not fixed to each other, it is possible to suppress falling off of all the steel sheet pieces 130p from the first resin portion 140. However, in a case in which the plurality of steel sheet pieces 130p are fixed to each other by caulking or the like, the retaining portion may be provided on at least one of the steel sheet pieces 130p.

[Second Embodiment] FIG. 16 is a perspective view of a stator 260 of the second embodiment.

The stator 260 of the second embodiment is different from the above-described embodiment mainly in configurations of a first resin portion 240, a second resin portion 250, and a busbar 266.

Constituent elements having identical aspects to those in the above-described embodiment are denoted by identical reference signs, and description thereof will be omitted.

Similarly to the above-described embodiment, the stator 260 of the present embodiment includes the plurality of teeth 30, the plurality of coils 63, the first resin portion 240, the second resin portion 250, and a plurality of (three in the present embodiment) the busbars 266.

Similarly to the above-described embodiment, the plurality of teeth 30 are arranged along the circumferential direction. The coils 63 are mounted to the teeth 30 via insulator portions 242 described later. The plurality of coils 63 include the U-phase, V-phase, and W-phase coils 63. The busbars 266 are connected to the plurality of coils 63.

One of the three busbars 266 connects the U-phase coil 63 and the V-phase coil 63, another one connects the V-phase coil 63 and the W-phase coil 63, and the remaining one connects the W-phase coil 63 and the U-phase coil 63. By this, the three busbars 266 connect the plurality of coils 63 to constitute a Δ connection. That is, the plurality of busbars 266 electrically connect the coils 63 to each other.

The stator 260 of the present embodiment is provided with the three busbars 266. The three busbars 266 have the same shape as each other. The three busbars 266 are arranged symmetrically around the center axis J. Each of the three busbars 266 includes a base portion 266b extending along the axial direction and a pair of connection terminal portions 266c extending in parallel radially outward from a lower end portion of the base portion 266b. An upper end of the base portion 266b is connected to the external power supply. The connection terminal portions 266c are connected to the coils 63.

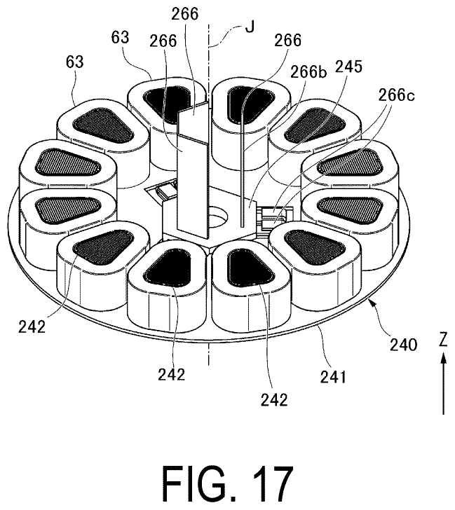

FIG. 17 is a view of the stator 260 of the present embodiment in which the second resin portion 250 is omitted. The first resin portion 240 of the present embodiment includes the plurality of insulator portions 242, a bottom wall portion 241, and a busbar holding portion 245.

The insulator portions 242 cover at least a part of the outer side surfaces of the teeth 30 similarly to the above-described embodiment. The bottom wall portion 241 has a disc shape extending along a plane orthogonal to the center axis J around the center axis J. The bottom wall portion 241 is connected to lower end portions of the insulator portions 242. By this, the bottom wall portion 241 connects the plurality of insulator portions 242 to each other.

The busbar holding portion 245 is located at the center of the bottom wall portion 241. The busbar holding portion 245 is located radially inward of the plurality of teeth 30. The busbar holding portion 245 projects upward from an upper surface of the bottom wall portion 241. The busbar holding portion 245 of the present embodiment has a hexagonal prism shape extending along the axial direction Z.

A part of the plurality of busbars 266 is embedded in the busbar holding portion 245. The base portion 266b extends upward from an upper surface of the busbar holding portion 245. The connection terminal portions 266c extend radially outward from surfaces facing radially outward of the busbar holding portion 245.

The first resin portion 240 of the present embodiment is molded by insert-molding for embedding the plurality of busbars 266 together with the plurality of teeth 30. That is, the first resin portion 240 of the present embodiment holds the plurality of teeth 30 and the plurality of busbars 266. Therefore, the first resin portion 240 can fix the plurality of teeth 30 to each other and the plurality of busbars 266 to each other, and can fix the teeth 30 and the busbars 266 to each other. Therefore, it is possible to omit a step of mounting the busbars 266 to the coils 63, and it is possible to manufacture the stator 260 at low cost by simplifying the manufacturing of the stator 260.

As shown in FIG. 16, the second resin portion 250 covers at least a part of the plurality of coils 63, at least a part of the plurality of busbars 266, and at least a part of the first resin portion 240. The second resin portion 250 of the present embodiment is molded by a mold. The second resin portion 250 is molded by insert-molding for embedding the plurality of coils 63, the plurality of busbars 266, and the first resin portion 240.

The thermal conductivity of the material constituting the second resin portion 250 of the present embodiment is the same as that of the material constituting the first resin portion 240. On the other hand, the material constituting the second resin portion 250 may be different from the material constituting the first resin portion 240. In this case, the thermal conductivity of the material constituting the second resin portion 250 is preferably higher than the thermal conductivity of the material constituting the first resin portion 240, similarly to the first embodiment. According to the present embodiment, heat can be absorbed from the coils 63 embedded by the second resin portion 250 and can be dissipated to the atmosphere or another member.

The second resin portion 250 has a disc shape around the center axis J. The second resin portion 250 is located above the bottom wall portion 241 of the first resin portion 240. The second resin portion 250 embeds the plurality of coils 63.

The second resin portion 250 includes a shaft 251. The shaft 251 extends upward from an upper surface of a portion of the second resin portion 250 in which the plurality of coils 63 are embedded. The shaft 251 has a columnar shape extending in the axial direction Z around the center axis J. The inner ring of the first bearing 17 (see FIG. 1) of the rotor 10 is fitted into the shaft 251. By this, the shaft 251 rotatably supports the rotor 10. According to the present embodiment, since the second resin portion 250 includes the shaft 251, it is not necessary to separately prepare a member for the shaft, and it is possible to reduce the manufacturing cost of the stator 260 by reducing the number of components of the stator 260. In the present embodiment, a case in which the shaft 251 is a part of the second resin portion 250 has been described, but the shaft 251 may be a part of another member such as the first resin portion 240.

The shaft 251 embeds the base portions 266b of the plurality of busbars 266. Further, an upper end portion of the base portion 266b projects upward from an upper end surface of the shaft 251. The upper end portion of the base portion 266b is inserted into and connected to a socket portion of the external power supply, for example. The shaft 251 supports the base portions 266b by embedding the base portions 266b. Therefore, even in a case in which the base portion 266b receives stress from the socket of the external power supply at the upper end portion, it is possible to suppress collapse of the base portion 266b.

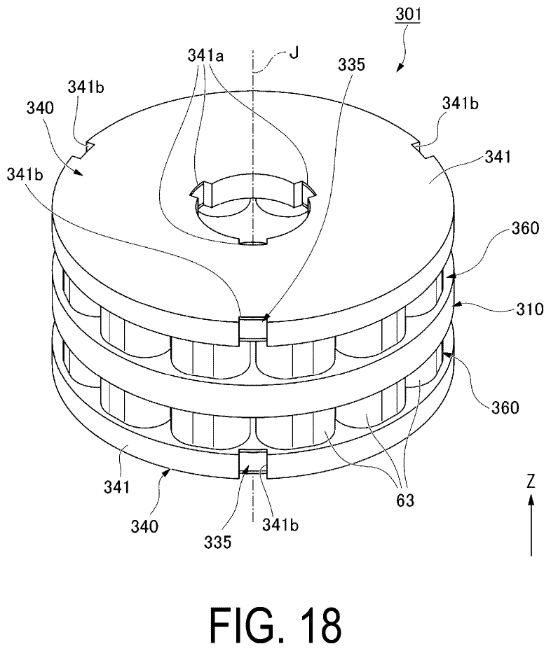

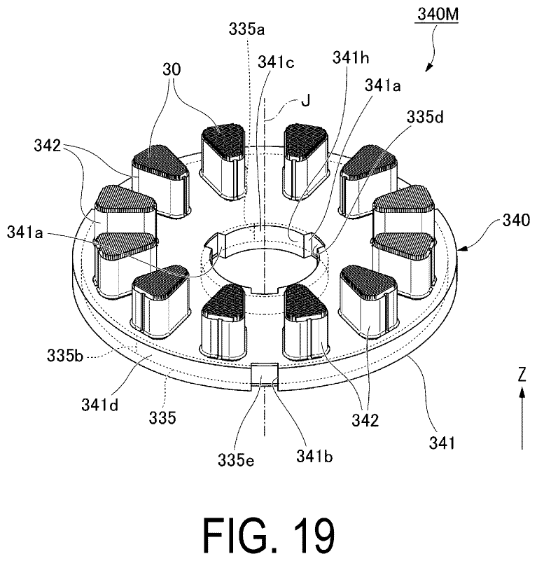

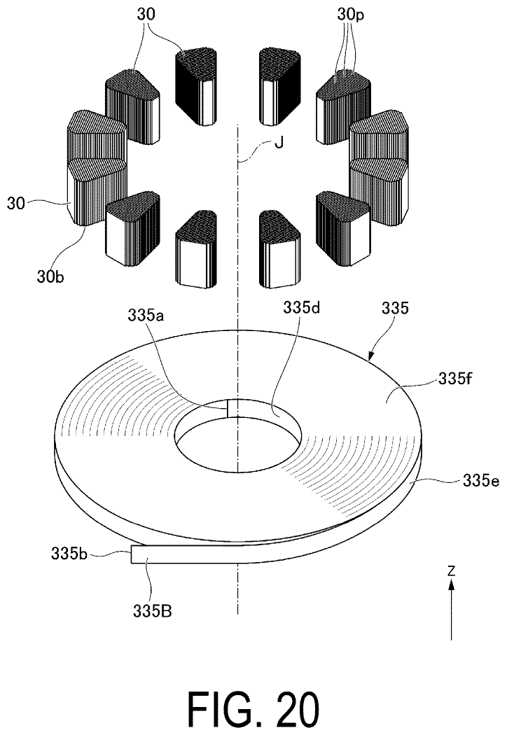

According to the stator 260 of the present embodiment, at least a part of the plurality of busbars 266 is embedded in the shaft 251, which is a part of the second resin portion 250. According to the present embodiment, by embedding the busbars 266 inside the shaft 251, the busbars 266 can be supported by the shaft 251.

[Third Embodiment] FIG. 18 is a perspective view of a motor 301 of the third embodiment. FIG. 19 is a perspective view of a molded component 340M of the third embodiment. FIG. 20 is an exploded perspective view of the plurality of teeth 30 and a back yoke 335 of the third embodiment.

Constituent elements having identical aspects to those in the above-described embodiment are denoted by identical reference signs, and description thereof will be omitted.

As shown in FIG. 18, the motor 301 of the present embodiment includes a pair of stators 360 and one rotor 310 arranged between the pair of stators 360. The pair of stators 360 of the present embodiment opposes the rotor 310 in the axial direction Z with a gap therebetween. The motor 301 of the present embodiment is a double-stator single-rotor type axial gap motor. Although not illustrated, the rotor 310 includes a magnet group (see FIG. 1) similar to that of the rotor 310 of the first embodiment.

The pair of stators 360 has the same structure. The pair of stators 360 is arranged to be inverted in the axial direction Z. In the following description, the stator 360 will be described with reference to the posture of the one located on a lower side of the pair of stators 360.

The stator 360 of the present embodiment includes the plurality of teeth 30 (see FIG. 19), the plurality of coils 63, the back yoke 335, and a first resin portion 340. The plurality of teeth 30 and the back yoke 335 are embedded in the first resin portion 340. In the following description, the plurality of teeth 30, the back yoke 335, and the first resin portion 340 in which these are embedded are referred to as the molded component 340M.

As shown in FIG. 20, the plurality of teeth 30 are arranged along the circumferential direction. Similarly to the above-described embodiment, the plurality of teeth 30 are constituted by the plurality of steel sheet pieces 30p having the radial direction as a stacking direction.

The back yoke 335 is located below the plurality of teeth 30. The back yoke 335 has an annular shape around the center axis J. The lower surfaces 30b of the plurality of teeth 30 are in contact with an upper surface 335f of the back yoke 335. Magnetic fluxes flowing downward from the lower surfaces 30b of the teeth 30 enter the back yoke 335. The back yoke 335 serves as a path of magnetic fluxes flowing between the plurality of teeth 30, and reduces magnetic resistance between the teeth 30.

The back yoke 335 of the present embodiment is constituted by a steel sheet 335B having a strip shape spirally wound around the center axis J without any gap. The back yoke 335 includes an inner circumferential surface 335d facing radially inward and an outer circumferential surface 335e facing radially outward.

In the following description, the steel sheet 335B constituting the back yoke 335 is referred to as a strip-shaped steel sheet. The strip-shaped steel sheet 335B of the present embodiment is continuous. The strip-shaped steel sheet 335B includes an inner circumferential end portion 335a, which is an end portion on an inner circumferential side, and an outer circumferential end portion 335b, which is an end portion on an outer circumferential side. The inner circumferential end portion 335a is located on the inner circumferential surface 335d of the back yoke 335, and the outer circumferential end portion 335b is located on the outer circumferential surface 335e of the back yoke 335.

As shown in FIG. 19, the first resin portion 340 of the present embodiment includes a plurality of insulator portions 342 and a bottom wall portion 341. The insulator portions 342 cover at least a part of the outer side surfaces of the teeth 30. On the other hand, the bottom wall portion 341 covers at least a part of the back yoke 335. The bottom wall portion 341 has a disc shape extending along a plane orthogonal to the center axis J. The bottom wall portion 341 is connected to lower end portions of the insulator portions 342. By this, the bottom wall portion 341 connects the plurality of insulator portions 342 to each other.

The bottom wall portion 341 is provided with a central hole 341h around the center axis J. The central hole 341h penetrates the bottom wall portion 341 in the axial direction Z. In the following description, an “inner edge of the bottom wall portion 341” means an inner circumferential surface surrounding the central hole 341h in the bottom wall portion 341, and an “outer edge of the bottom wall portion 341” means an outer circumferential surface of the bottom wall portion 341.

The inner edge of the bottom wall portion 341 of the present embodiment is provided with a first recess portion 341a. The first recess portion 341a is recessed radially outward from the inner edge of the bottom wall portion 341. A plurality of the first recess portions 341a are arranged at equal intervals along the circumferential direction. The inner circumferential surface 335d of the back yoke 335 is exposed on a bottom surface of the first recess portion 341a. Here, the bottom surface of the first recess portion 341a is a surface facing radially inward of an inner side surface of the first recess portion 341a.

The first recess portion 341a is arranged at a position in the circumferential direction different from the inner circumferential end portion 335a of the strip-shaped steel sheet 335B. Therefore, the inner circumferential end portion 335a of the strip-shaped steel sheet 335B is covered with the first resin portion 340 without being exposed from the bottom surface of the first recess portion 341a. Here, a portion covering the inner circumferential end portion 335a of the strip-shaped steel sheet 335B at the inner edge of the bottom wall portion 341 is a first covering portion 341c.

The outer edge of the bottom wall portion 341 is provided with a plurality of (three in the present embodiment) second recess portions 341b. The second recess portions 341b are recessed radially inward from the outer edge of the bottom wall portion 341. The plurality of second recess portions 341b are arranged at equal intervals along the circumferential direction. The outer circumferential surface 335e of the back yoke 335 is exposed on bottom surfaces of the second recess portions 341b. Here, the bottom surface of the second recess portion 341b is a surface facing radially outward of an inner side surface of the second recess portion 341b.

The second recess portions 341b are arranged at positions different in the circumferential direction from the outer circumferential end portion 335b of the strip-shaped steel sheet 335B. Therefore, the outer circumferential end portion 335b of the strip-shaped steel sheet 335B is covered with the first resin portion 340 without being exposed from the bottom surfaces of the second recess portions 341b. Here, a portion covering the outer circumferential end portion 335b of the strip-shaped steel sheet 335B at the outer edge of the bottom wall portion 341 is a second covering portion 341d.

The first resin portion 340 of the present embodiment includes the first covering portion 341c covering the inner circumferential end portion 335a of the strip-shaped steel sheet 335B and the second covering portion 341d covering the outer circumferential end portion 335b. The back yoke 335 has a spiral shape easily collapsing from the inner circumferential end portion 335a and the outer circumferential end portion 335b of the strip-shaped steel sheet 335B. According to the present embodiment, the inner circumferential end portion 335a and the outer circumferential end portion 335b of the strip-shaped steel sheet 335B are covered with the first resin portion 340, whereby it is possible to suppress collapse of the spiral shape of the back yoke 335 from the end portions. According to the present embodiment, it is not necessary to fix the inner circumferential end portion 335a and the outer circumferential end portion 335b by a fixing means such as caulking or welding. Therefore, not only the manufacturing process of the stator 360 can be simplified, but also deterioration of magnetic characteristics of the strip-shaped steel sheet 335B accompanying a step such as caulking or welding can be suppressed.

The inner circumferential surface 335d and the outer circumferential surface 335e of the back yoke 335 of the present embodiment are covered with the bottom wall portion 341 of the first resin portion 340. The stator 360 of the present embodiment can be fixed to a holding member such as a housing with reference to the inner edge or the outer edge of the bottom wall portion 341, which is a resin molding surface. This facilitates dimensional management and securing of coaxiality when the stator 360 is fixed to the holding member.

In the present embodiment, a case in which both end portions (the inner circumferential end portion 335a and the outer circumferential end portion 335b) of the strip-shaped steel sheet 335B are covered with the first resin portion 340 has been described. However, as long as the end portion of at least one of the inner circumferential end portion 335a and the outer circumferential end portion 335b is covered with the first resin portion 340, collapse of the shape of the back yoke 335 from the end portion can be suppressed. In a case of covering only one end portion with the first resin portion 340, it is conceivable to fix the other end portion by a fixing means such as caulking or welding.

The first resin portion 340 of the present embodiment is molded by insert-molding for embedding the back yoke 335 together with the plurality of teeth 30. That is, since the first resin portion 340 of the present embodiment holds the plurality of teeth 30 and the back yoke 335, the plurality of teeth 30 can be fixed to each other, and the plurality of teeth 30 and the back yoke 335 can be fixed to each other. This can omit the step of fixing the teeth 30 and the back yoke 335, and can simplify the manufacturing process of the stator 360. A contact state between the teeth 30 and the back yoke 335 can be stabilized, and the function of the back yoke 335 can be enhanced.

According to the present embodiment, the back yoke 335 is configured by winding the strip-shaped steel sheet 335B into a spiral shape. For this reason, offcuts of the steel sheet are not generated during manufacturing, and the yield of the steel sheet can be increased, as compared with a case in which the steel sheets are stacked by press working.

In the present embodiment, a case in which the back yoke 335 is constituted by the steel sheet 335B having a strip shape has been described, but the back yoke may be constituted by an annular thin steel sheet having the axial direction Z as a thickness direction.

Next, a method for manufacturing the stator 360 of the present embodiment will be described. In the following description, description of steps similar to those in the above-described embodiment will be omitted.

The method for manufacturing the stator 360 of the present embodiment includes a strip-shaped steel sheet molding step, an arranging step, a molding step, and a mounting step. In the method for manufacturing the stator 360 of the present embodiment, the strip-shaped steel sheet molding step, the arranging step, the molding step, and the mounting step are performed in this order.

The method for manufacturing the stator 360 of the present embodiment is different from the method for manufacturing of the first embodiment mainly in that the strip-shaped steel sheet molding step is performed before the arranging step, the back yoke 335 is arranged in the cavity C in the arranging step, the back yoke 335 is embedded with the first resin portion 340 in the molding step, and the like.

In the method for manufacturing the stator 360 of the present embodiment, it is preferable to perform a steel sheet cutting step similar to that of the first embodiment described above before the arranging step. Further, similarly to the above-described embodiment, the mounting step is a step of assembling the plurality of coils 63, the busbars, and the like.

As shown in FIG. 20, the strip-shaped steel sheet molding step is a step of forming the back yoke 335 by winding one strip-shaped steel sheet 335B into a spiral shape having a thickness direction as a radial direction.

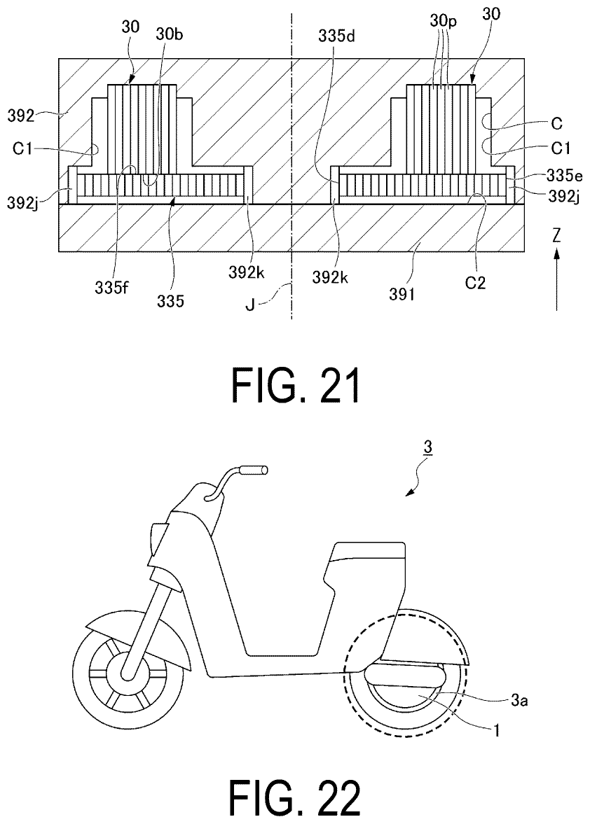

FIG. 21 is a schematic sectional view along the radial direction of molds 391 and 392 for molding the first resin portion 340 of the present embodiment. The molds 391 and 392 include a first mold 391 and a second mold 392. The first mold 391 and the second mold 392 are arranged to face each other in the axial direction Z. The cavity C is provided between the first mold 391 and the second mold 392. The cavity C includes the plurality of first spaces C1 and the second space C2. The first spaces C1 are spaces for molding the insulator portions 342. The teeth 30 are arranged in the first spaces C1. The second space C2 is a space for molding the bottom wall portion 341. The back yoke 335 is arranged in the second space C2.

The second space C2 has an annular shape extending along the circumferential direction. The second mold 392 includes an inner inside surface surrounding the second space C2 from radially inward and facing radially outward, and an outer inside surface surrounding the second space C2 from radially outward and facing radially inward. The inner inside surface and the outer inside surface of the second mold 392 oppose each other in the radial direction. The inner inside surface and the outer inside surface of the second mold 392 each extend along the circumferential direction. The inner inside surface of the second mold 392 is provided with a plurality of inner protrusion portions 392k. The inner protrusion portions 392k project radially outward. The plurality of inner protrusion portions 392k are arranged at equal intervals along the circumferential direction. The outer inside surface is provided with a plurality of outer protrusion portions 392j. The outer protrusion portions 392j project radially inward. The plurality of outer protrusion portions 392j are arranged at equal intervals along the circumferential direction.

The arranging step is a step of arranging the plurality of teeth 30 and the back yoke 335 in the cavity C. The back yoke 335 is arranged in the cavity C in a state of being in contact with the end surfaces (the lower surfaces 30b) facing in the axial direction Z of the plurality of teeth 30. In the arranging step, the back yoke 335 is pressed against the lower surfaces 30b of the plurality of teeth 30 using a pin or the like not illustrated, and the upper surface 335f of the back yoke 335 is brought into contact with the lower surfaces 30b of the plurality of teeth 30.

In the arranging step of the present embodiment, the inner circumferential surface 335d of the back yoke 335 is in contact with the plurality of inner protrusion portions 392k, and the outer circumferential surface 335e of the back yoke 335 is in contact with the plurality of outer protrusion portions 392j. By this, the back yoke 335 is held in the second space C2 of the cavity C and positioned with respect to the inner side surfaces of the molds 391 and 392. Further, a portion in contact with the inner protrusion portions 392k of the inner circumferential surface 335d of the back yoke 335 and a portion in contact with the outer protrusion portions 392j of the outer circumferential surface 335e are less likely to be in contact with the molten resin material in the cavity C. Therefore, these portions are exposed from the bottom wall portion 341 of the first resin portion 340 after the molding of the first resin portion 340. Further, the first recess portions 341a and the second recess portions 341b as traces of the inner protrusion portions 392k and the outer protrusion portions 392j are formed in the inner edge and the outer edge, respectively, of the bottom wall portion 341.

According to the method for manufacturing of the present embodiment, in the molding step, the plurality of insulator portions 342 are molded, and the bottom wall portion 341 connecting the plurality of insulator portions 342 is also molded. Further, in the molding step, the back yoke 335 is held by the first resin portion 340 by molding the bottom wall portion 341. Therefore, in the molding step, the plurality of teeth 30 can be relatively fixed to each other, and the plurality of teeth 30 and the back yoke 335 can be relatively fixed to each other, as well as molding of the insulator portions 342, and the method for manufacturing can be simplified.

Next, an example of a device equipped with the motor 1 of each of the above-described embodiments will be described.

Here, the motor 1 shown in each drawing may be any motor of each of the embodiments, that is, may be a motor including any stator of each of the embodiments.

<Motorcycle> FIG. 22 is a side view of an electric two-wheeled vehicle 3 including the motor 1.

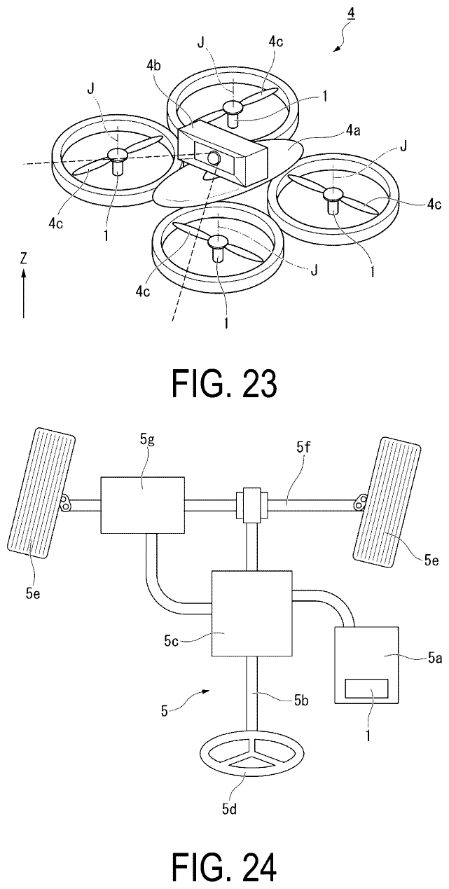

The motor 1 is arranged inside a wheel 3a of a rear wheel of the electric two-wheeled vehicle 3. The motor 1 rotates the wheel 3a with respect to a chassis of the electric two-wheeled vehicle 3. The motor 1 may be arranged inside a wheel of a front wheel of the electric two-wheeled vehicle. The motor 1 may be arranged inside a wheel such as a bicycle, an electric four-wheeled vehicle, or a wheelchair.

<Unmanned Aerial Vehicle> FIG. 23 is a perspective view of an unmanned aerial vehicle 4 including the motor 1.

The unmanned aerial vehicle 4 of the present embodiment includes a main body portion 4a, an image capturing device 4b, a plurality of (four in the present embodiment) the motors 1, and a propeller 4c to be connected to the rotor of each of the motors 1. Each of the motors 1 rotates the propeller 4c around the corresponding center axis J.

<Electric Power Steering Device> FIG. 24 is a schematic view of an electric power steering device 5 including the motor 1.

The electric power steering device 5 is equipped on a steering mechanism of a wheel of an automobile. The electric power steering device 5 is a device that reduces a steering force by hydraulic pressure. The electric power steering device 5 of the present embodiment includes the motor 1, an oil pump 5a, a steering shaft 5b, and a control valve 5c. The steering shaft 5b transmits input from a steering 5d to an axle 5f including wheels 5e. The oil pump 5a generates hydraulic pressure in a power cylinder 5g. The power cylinder 5g transmits driving force by hydraulic pressure to the axle 5f. The control valve 5c controls oil of the oil pump 5a. In the electric power steering device 5, the motor 1 is equipped as a drive source of the oil pump 5a.

While preferred embodiments according to the present disclosure have been described above with reference to the accompanying drawings, it goes without saying that the present disclosure is not limited to such examples. Various shapes, combinations, and the like of the constituent members shown in the above-described examples are merely examples, and various modifications can be made based on design requirements and the like in a scope without departing from the gist of the present disclosure.

The motor to which the present disclosure is applied is applicable to various devices. The motor can be applied to a rotating electric machine such as a generator, for example. In this case, the motor may be a three-phase alternating-current generator. The application of the motor is not particularly limited. The number of poles and the number of slots of the motor are not particularly limited. In the motor, the coil may be configured by any winding method. As described above, the configurations described in the present specification can be appropriately combined within a range not contradictory to each other.

The present technology can have the following configurations.
(1) A stator opposing, in an axial direction, a rotor rotatable around a center axis, the stator including: a plurality of teeth arranged in a circumferential direction; coils respectively mounted on the plurality of teeth; and a first resin portion holding the plurality of teeth, in which the first resin portion includes insulator portions located between the teeth and the coils.
(2) The stator according to (1), in which a surface of each of the teeth is provided with an exposed portion exposed from the insulator portion, and the exposed portion includes an exposed end surface located on an end surface facing in the axial direction of each of the teeth, and an exposed outer side surface continuous with the exposed end surface and facing a direction orthogonal to the axial direction.
(3) The stator according to (2), in which the teeth include a plurality of steel sheet pieces stacked along a stacking direction, and the exposed outer side surface includes a pair of exposed surfaces provided on end surfaces on one side and an other side in the stacking direction.
(4) The stator according to (3), in which the pair of exposed surfaces includes straight portions extending straight along the axial direction.
(5) The stator according to any one of (1) to (4), in which a surface of each of the teeth is provided with a retaining portion including a protrusion portion projecting in the circumferential direction or a recess portion recessed in the circumferential direction, and the retaining portion is covered with the insulator portion.
(6) The stator according to any one of (1) to (5), further including a back yoke held by the first resin portion and in contact with end surfaces facing in the axial direction of the plurality of teeth.
(7) The stator according to (6), in which the back yoke is configured by winding a steel sheet having a strip shape into a spiral shape.
(8) The stator according to (7), in which the first resin portion includes a covering portion covering an end portion of the steel sheet having a strip shape.
(9) The stator according to any one of (1) to (8), further including a plurality of busbars electrically connecting the coils to each other, in which the busbars are held by the first resin portion.
(10) The stator according to any one of (1) to (9), further including a second resin portion covering at least a part of the plurality of coils, in which the second resin portion includes a shaft extending in the axial direction around the center axis.
(11) The stator according to any one of (1) to (10), further including: a plurality of busbars electrically connecting the coils to each other; and a second resin portion covering at least a part of each of the plurality of coils, in which the second resin portion includes a shaft extending in the axial direction around the center axis, and at least a part of each of the plurality of busbars is embedded in the shaft.
(12) The stator according to any one of (1) to (11), further including a busbar connecting the coils to each other, in which some of the plurality of coils include first connection portions to be connected to the busbar, and the first connection portions of the coils to be connected by the busbar have axial positions coinciding with each other.
(13) The stator according to any one of (1) to (12), further including a plurality of busbars connecting the plurality of coils, in which the plurality of busbars overlap each other as viewed from the axial direction.
(14) The stator according to any one of (1) to (13), further including: a power supply line to be connected to an external power supply; and a busbar connecting the coils to each other, in which some of the plurality of coils include first connection portions to be connected to the busbar, some of the plurality of coils include second connection portions to be connected to the power supply line, and axial positions of at least one of the first connection portions and at least one of the second connection portions coincide with an axial position of lower end portions of the coils.
(15) The stator according to (14), further including a shaft located radially inward of the plurality of teeth, in which the shaft includes a hollow portion extending in the axial direction and opening at an end portion of the shaft, and a plurality of hole portions extending radially outward from the hollow portion, and the plurality of hole portions are arranged to overlap an axial range in which the plurality of busbars are arranged.
(16) The stator according to any one of (1) to (15), further including a second resin portion, in which the first resin portion includes an outer wall portion surrounding the plurality of teeth from a radially outer side, an inner wall portion located radially inward of the plurality of teeth, and a bottom wall portion connecting the outer wall portion and the inner wall portion and covering the plurality of coils from one side in the axial direction, the second resin portion is filled in a region surrounded by the outer wall portion, the inner wall portion, and the bottom wall portion and covers at least a part of each of the plurality of coils, and a thermal conductivity of a material constituting the second resin portion is higher than a thermal conductivity of a material constituting the first resin portion.
(17) The stator according to (16), further including a shaft made of metal located radially inward of the plurality of teeth, in which the second resin portion is in contact with the shaft.
(18) A motor including: the stator according to any one of (1) to (17); and the rotor.
(19) A method for manufacturing a stator opposing, in an axial direction, a rotor rotatable around a center axis, the method including: an arranging step of arranging a plurality of teeth in a cavity of a mold; a molding step of filling the cavity with resin, molding a first resin portion, forming an insulator portion on a surface of each of the teeth, and holding the plurality of teeth with the first resin portion; and a mounting step of mounting a coil on the teeth via the insulator portion.
(20) The method for manufacturing a stator according to (19), in which an inner side surface of the mold is provided with an accommodating recess portion accommodating end portions in the axial direction of the teeth, and in the arranging step and the molding step, the inner side surface of the accommodating recess portion is in contact with end surfaces facing in the axial direction of the teeth and an outer side surface continuous with the end surfaces and facing a direction orthogonal to the axial direction.
(21) The method for manufacturing a stator according to (19) or (20), in which the teeth include a plurality of steel sheet pieces stacked along a stacking direction, and an inner side surface of the mold is provided with a pair of pressing surfaces in contact with end surfaces on one side and an other side in the stacking direction of the teeth.
(22) The method for manufacturing a stator according to (21), in which the mold includes a pressing portion that is arranged on a surface facing in the stacking direction among inner side surfaces surrounding the cavity and is movable in the stacking direction, and the pressing portion includes one of the pressing surfaces and presses the teeth against the other of the pressing surfaces.
(23) The method for manufacturing a stator according to any one of (19) to (22), further including a steel sheet cutting step performed before the arranging step, in which the steel sheet cutting step is a step of cutting a steel sheet having a strip shape along a cutting line extending along a width direction to form a plurality of steel sheet pieces, and the arranging step is a step of stacking and arranging, in the cavity, the plurality of steel sheet pieces.
(24) The method for manufacturing a stator according to (23), in which the cutting line has a protruding shape projecting toward one side in a length direction of the steel sheet having a strip shape.
(25) The method for manufacturing a stator according to any one of (19) to (24), further including a strip-shaped steel sheet molding step performed before the arranging step, in which the strip-shaped steel sheet molding step is a step of forming a back yoke by winding one steel sheet having a strip shape into a spiral shape having a thickness direction as a radial direction, the arranging step is a step of arranging the back yoke in the cavity in a state of being in contact with end surfaces facing in the axial direction of the plurality of teeth, and the molding step is a step of holding the back yoke with the first resin portion.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator opposing, in an axial direction, a rotor rotatable around a center axis, the stator comprising:
a plurality of teeth arranged in a circumferential direction;
coils respectively mounted on the plurality of teeth; and
a first resin portion holding the plurality of teeth, wherein
the first resin portion includes insulator portions located between the teeth and the coils.

2. The stator according to claim 1, wherein
a surface of each of the teeth is provided with an exposed portion exposed from the insulator portion, and
the exposed portion includes an exposed end surface located on an end surface facing in the axial direction of each of the teeth, and
an exposed outer side surface continuous with the exposed end surface and facing a direction orthogonal to the axial direction.

3. The stator according to claim 2, wherein
the teeth include a plurality of steel sheet pieces stacked along a stacking direction, and
the exposed outer side surface includes a pair of exposed surfaces provided on end surfaces on one side and an other side in the stacking direction.

4. The stator according to claim 3, wherein the pair of exposed surfaces includes straight portions extending straight along the axial direction.

5. The stator according to claim 1, wherein
a surface of each of the teeth is provided with a retaining portion including a protrusion portion projecting in the circumferential direction or a recess portion recessed in the circumferential direction, and
the retaining portion is covered with the insulator portion.

6. The stator according to claim 1, further comprising a back yoke held by the first resin portion and in contact with end surfaces facing in the axial direction of the plurality of teeth.

7. The stator according to claim 6, wherein the back yoke is configured by winding a steel sheet having a strip shape into a spiral shape.

8. The stator according to claim 7, wherein the first resin portion includes a covering portion covering an end portion of the steel sheet having a strip shape.

9. The stator according to claim 1, further comprising a plurality of busbars electrically connecting the coils to each other, wherein
the busbars are held by the first resin portion.

10. The stator according to claim 1, further comprising a second resin portion covering at least a part of the plurality of coils, wherein
the second resin portion includes a shaft extending in the axial direction around the center axis.

11. The stator according to claim 1, further comprising:
a plurality of busbars electrically connecting the coils to each other; and
a second resin portion covering at least a part of each of the plurality of coils, wherein
the second resin portion includes a shaft extending in the axial direction around the center axis, and
at least a part of each of the plurality of busbars is embedded in the shaft.

12. The stator according to claim 1, further comprising a busbar connecting the coils to each other, wherein
some of the plurality of coils include first connection portions to be connected to the busbar, and the first connection portions of the coils to be connected by the busbar have axial positions coinciding with each other.

13. The stator according to claim 1, further comprising a plurality of busbars connecting the plurality of coils, wherein
the plurality of busbars overlap each other as viewed from the axial direction.

14. The stator according to claim 1, further comprising:
a power supply line to be connected to an external power supply; and
a busbar connecting the coils to each other, wherein
some of the plurality of coils include first connection portions to be connected to the busbar,
some of the plurality of coils include second connection portions to be connected to the power supply line, and
axial positions of at least one of the first connection portions and at least one of the second connection portions coincide with an axial position of lower end portions of the coils.

15. The stator according to claim 14, further comprising a shaft located radially inward of the plurality of teeth, wherein
the shaft includes
a hollow portion extending in the axial direction and opening at an end portion of the shaft, and
a plurality of hole portions extending radially outward from the hollow portion, and
the plurality of hole portions are arranged to overlap an axial range in which the plurality of busbars are arranged.

16. The stator according to claim 1, further comprising a second resin portion, wherein
the first resin portion includes
an outer wall portion surrounding the plurality of teeth from a radially outer side,
an inner wall portion located radially inward of the plurality of teeth, and
a bottom wall portion connecting the outer wall portion and the inner wall portion and covering the plurality of coils from one side in the axial direction,
the second resin portion is filled in a region surrounded by the outer wall portion, the inner wall portion, and the bottom wall portion and covers at least a part of each of the plurality of coils, and
a thermal conductivity of a material constituting the second resin portion is higher than a thermal conductivity of a material constituting the first resin portion.

17. The stator according to claim 16, further comprising a shaft made of metal located radially inward of the plurality of teeth, wherein
the second resin portion is in contact with the shaft.

18. A motor comprising:
the stator according to claim 1; and
the rotor.

19. A method for manufacturing a stator opposing, in an axial direction, a rotor rotatable around a center axis, the method comprising:
an arranging step of arranging a plurality of teeth in a cavity of a mold;
a molding step of filling the cavity with resin, molding a first resin portion, forming an insulator portion on a surface of each of the teeth, and holding the plurality of teeth with the first resin portion; and
a mounting step of mounting a coil on the teeth via the insulator portion.

20. The method for manufacturing a stator according to claim 19, wherein
an inner side surface of the mold is provided with an accommodating recess portion accommodating end portions in the axial direction of the teeth, and
in the arranging step and the molding step, the inner side surface of the accommodating recess portion is in contact with end surfaces facing in the axial direction of the teeth and an outer side surface continuous with the end surfaces and facing a direction orthogonal to the axial direction.

21. The method for manufacturing a stator according to claim 19, wherein
the teeth include a plurality of steel sheet pieces stacked along a stacking direction, and
an inner side surface of the mold is provided with a pair of pressing surfaces in contact with end surfaces on one side and an other side in the stacking direction of the teeth.

22. The method for manufacturing a stator according to claim 21, wherein
the mold includes a pressing portion that is arranged on a surface facing in the stacking direction among inner side surfaces surrounding the cavity and is movable in the stacking direction, and
the pressing portion includes one of the pressing surfaces and presses the teeth against the other of the pressing surfaces.

23. The method for manufacturing a stator according to claim 19, further comprising a steel sheet cutting step performed before the arranging step, wherein
the steel sheet cutting step is a step of cutting a steel sheet having a strip shape along a cutting line extending along a width direction to form a plurality of steel sheet pieces, and
the arranging step is a step of stacking and arranging, in the cavity, the plurality of steel sheet pieces.

24. The method for manufacturing a stator according to claim 23, wherein the cutting line has a protruding shape projecting toward one side in a length direction of the steel sheet having a strip shape.

25. The method for manufacturing a stator according to claim 19, further comprising a strip-shaped steel sheet molding step performed before the arranging step, wherein
the strip-shaped steel sheet molding step is a step of forming a back yoke by winding one steel sheet having a strip shape into a spiral shape having a thickness direction as a radial direction,
the arranging step is a step of arranging the back yoke in the cavity in a state of being in contact with end surfaces facing in the axial direction of the plurality of teeth, and
the molding step is a step of holding the back yoke with the first resin portion.
